(19) United States
(12) Patent Application Publication
(10) Pub. No.: US 2026/0260325 A1
(43) Pub. Date: Sep. 3, 2026

(54) Identification of Inaccuracies in a Depth Frame/Image

(71) Applicant: POMMELHORSE LTD, Edinburgh (GB)

(72) Inventors: Seyed Danesh, Edinburgh (GB); Rahul Summan, Edinburgh (GB)

(21) Appl. No.: 19/165,341

(22) PCT Filed: Mar. 1, 2024
(86) PCT No.: PCT/GB2024/050561

§ 371 Date: Sep. 15, 2025

(30) Foreign Application Priority Data
Mar. 16, 2023 (GB) 2303852.4

(51) Int. Cl. G06T 7/00; G06T 7/11; G06T 7/55; G06T 7/90; G06V 10/56; G06V 10/82; G06V 20/40

(52) U.S. Cl. CPC G06T 7/0002; G06T 7/11; G06T 7/55; G06T 7/90; G06V 10/56; G06V 10/82; G06V 20/46; G06T 2207/10016; G06T 2207/10024; G06T 2207/20084

(57) ABSTRACT

The present disclosure relates to a method, system, apparatus and computer program for identifying incorrect pixels in depth frames of a video stream that is imaging one or more objects in a scene. It includes receiving a depth frame and a respective colour frame, and determining a first pixel mask for the colour frame. Using the depth frame and/or colour frame. Pixels of the current depth frame that correspond to the pixels of the first pixel mask and that have a depth value that is outside of the first depth range may then be marked as incorrect, for example by deleting the depth value.

### TECHNICAL FIELD

The present disclosure relates to methods, apparatus and computer programs configured to identify incorrect/inaccurate depth values in a depth frame/image, and optionally correct at least some of the identified depth values.

### BACKGROUND

A depth image (also referred to as a depth frame or depth map) is a three dimensional representation of a scene that is imaged from a viewpoint, for example from a camera. For example, a depth image may comprise a plurality of pixels arranged in a two-dimensional array (eg, x and y planes/dimensions). Each pixel should have a depth, or distance, value indicating a displacement in the third dimension (eg, z plane/dimension) to an object being imaged by that pixel. Depth images may be generated in a variety of different ways, for example using a Time of Flight (ToF) camera, or a LIDAR camera, or by image analysis of one or more colour/greyscale images (such as by analysis of two colour/greyscale images, such as stereo colour/greyscale images of a scene).

However, there may be errors or inaccuracies in the depth image, for example where the depth value of one or more pixels in the image are incorrect/inaccurate. One cause of error may be random noise, for example Gaussian noise. Another (sometimes very significant) cause of error may be from incorrect pixel matching. For example, if the depth image is generated using a pixel matching or triangulation system, such as by a stereo-to-depth system (where the depth image is generated by comparing pixels in two or more colour/greyscale images), potentially very significant depth errors may occur due to incorrect pixel matching when generating the depth frame.

Some previous imaging systems used a form of smoothing and aggregation to identify and correct some depth errors. Typically, these techniques identify pixels having a depth value that is significantly different from that of its neighbouring pixels. Those identified pixels are determined to be incorrect and the incorrect value is replaced with the values of the neighbouring pixels, or a weighted version of one or more neighbouring pixel depth values. However, such schemes tend to suffer from depth bleeding, where depth values from different parts of the imaged scene that might be at quite different depths to each other can bleed across the boundary of objects. For example, when imaging a person's facing, the distance to their face is less (closer) than the distance to a wall behind the person. However, because of the significant change in distance between neighbouring pixels around the edges of the persons face, some of those pixels may be identified as having incorrect depth values. In some instances those pixels may indeed be inaccurate, and in other instances they may actually be accurate but have been identified as inaccurate because of a sudden change in depth between neighbouring pixels. Furthermore, the values of those identified pixels may then be replaced with weighted or averaged versions of the neighbouring pixel depth values, which may result in a blurring or bleeding of the depth image around the edge of the person's face.

Therefore, there is a need more reliably to identify incorrect/inaccurate pixels in a depth image. Those more reliably identified incorrect/inaccurate pixels may then be corrected so that the resultant depth frame is a more accurate representation of depths in the imaged scene.

### SUMMARY

In a first aspect of the present disclosure, there is provided a method for identifying in real time incorrect pixels in depth frames of a video stream that is imaging one or more objects in a scene, wherein the video stream comprises a plurality of time-consecutive depth frames and a respective plurality of time-consecutive colour frames, the method comprising: receiving a current depth frame of the plurality of time-consecutive depth frames and a respective current colour frame of the plurality of time-consecutive colour frames; determining a first pixel mask for the current colour frame using at least one of: the current depth frame and the current colour frame, wherein the first pixel mask identifies each of the pixels of the current colour frame that are likely to be imaging at least one object surface that is within a first depth range; and marking as incorrect any pixels of the current depth frame that correspond to the pixels of the first pixel mask and that have a depth value that is outside of the first depth range.

Determining the first pixel mask may comprise comparing at least a part of the current colour frame to a reference colour frame that comprises a plurality of pixels that image at least one object surface that is within a reference depth range, wherein the reference colour frame is made up of pixels from one or more previous colour frames that precede the current colour frame in the plurality of time-consecutive colour frames.

The reference depth range may be the same as the first depth range, wherein the first pixel mask identifies pixels of the current colour frame that are determined, based at least on the comparison of the part of the current colour frame and the reference colour frame, as likely to be imaging the same object surface as that imaged by the corresponding pixel in the reference colour frame. Alternatively, the reference depth range is different to, and non-overlapping with, the first depth range, wherein the first pixel mask comprises pixels of the current colour frame that are determined, based at least on the comparison of the part of the current colour frame and the reference colour frame, as unlikely to be imaging the same object surface as that imaged by the corresponding pixels in the reference colour frame.

The first pixel mask may be determined based further on a comparison of at least a part of the current colour frame to a further reference colour frame that comprises a plurality of pixels that image at least one object surface that is within a further reference depth range.

Comparison of the part of the current colour frame to the reference colour frame may comprise, for each pixel in the part of the current colour frame: determining a similarity score to the corresponding pixel of the reference colour frame; and comparing the similarity score to at least one similarity threshold. The similarity threshold may be the same for each pixel of the current colour frame, or the similarity threshold is variable on a pixel by pixel basis.

Comparison of the part of the current colour frame to the reference colour frame may be performed by a neural network trained to determine when the part of the current colour frame is likely to be imaging at least one object surface that is within the first depth range.

Determining the first pixel mask for the current colour frame may further comprise: determining the part of the current colour frame to be compared against the reference colour frame based on at least one of: (a) the current depth frame and the first depth range; (b) the reference colour frame; (c) a pixel mask for a previous colour frame that precedes the current colour frame in the plurality of time-consecutive colour frames; (d) a further reference colour frame that comprises a plurality of pixels that image at least one object surface that is within a further reference depth range.

The method may further comprise identifying a high confidence part of the current colour frame, wherein the high confidence part comprises pixels of the colour frame that are not in the part of the current colour frame to be compared against the reference colour frame, and that are determined to be likely to be imaging at least one object surface that is within the first depth range, and wherein the first pixel mask comprises: the pixels of the high confidence part; and the pixels of the part of the current colour frame that are compared to the reference colour frame and are determined, based at least on that comparison, to be likely to be imaging at least one object surface that is within the first depth range.

Identifying the high confidence part of the current colour frame may be based on at least one of: (a) the current depth frame and the first depth range; (b) the reference colour frame; (c) a pixel mask for a previous colour frame that precedes the current colour frame in the plurality of time-consecutive colour frames; (d) a further reference colour frame that comprises a plurality of pixels that image at least one object surface that is within a further reference depth range.

The method of any preceding claim, further comprising: generating an updated reference colour frame using the reference colour frame, the first pixel mask and the current colour frame; and storing the updated reference colour frame for use in determining at least one pixel mask for a future colour frame that that follows the current colour frame in the plurality of time-consecutive colour frames.

Generating the updated reference colour frame may comprise: generating, using at least the first pixel mask and the reference colour frame: a common pixel mask that identifies pixels that image, in both the current colour frame and the reference colour frame, at least one object surface that is within the reference depth range; and a reference only pixel mask that identifies pixels that image, in the reference colour frame and not in the current colour frame, at least one object surface that is within the reference depth frame; and generating a set of pixels using pixels of the reference colour frame that correspond to the reference only pixel mask; wherein the updated reference colour frame comprises the set of pixels and pixels of the current colour frame that correspond to the common pixel mask.

Generating the second set of pixels comprises adjusting at least one colour coefficient of the reference colour frame pixels that correspond to the reference only pixel mask so that of the appearance of the second set of pixels is consistent with the appearance of the current colour frame. Adjusting the at least one colour coefficient of the reference colour frame pixels may comprise: comparing colour coefficients of the current colour frame pixels that correspond to the common pixel mask against colour coefficients of the reference colour frame pixels that correspond to the common pixel mask; determining, based on that comparison, an adjustment of the colour coefficients of the reference colour frame pixels that correspond to the common pixel mask that would result in them matching the colour coefficients of the current colour frame pixels that correspond to the common pixel mask; and applying the determined adjustment to the reference colour frame pixels that correspond to the reference only pixel mask.

Generating the updated reference frame may further comprise: identifying a feature in the current colour frame; identifying the feature in the reference colour frame; and determining a transformation of the reference colour frame that would align the feature in the reference colour frame with the feature in the current colour frame, wherein generating the set of pixels comprises applying the transformation to the reference colour frame pixels corresponding to the reference only pixel mask.

The method may further comprise marking as incorrect any pixels of the current depth frame that do not correspond to the pixels of the first pixel mask and that have a depth value that is within the first depth range.

The method may further comprise determining a second pixel mask for the current colour frame, wherein the second pixel mask identifies each of the pixels of the current colour frame that are likely to be imaging an object surface in a second depth range; and marking as incorrect any pixels of the current depth frame that correspond to the pixels of the second pixel mask and that have a depth value that is outside of the second depth range. The second pixel mask may be determined based on the first pixel mask, wherein the second pixel mask is the inverse of the first pixel mask.

Identification of the feature in the current colour frame comprises performing feature detection on only the current colour frame pixels that correspond to the common pixel mask, wherein identification of the feature in the reference colour frame comprises performing feature detection on only the reference colour frame pixels that correspond to the common pixel mask.

The method may further comprise setting the first depth range based on range data comprising at least one of: one or more previous depth frames that precede the current depth frame in the plurality of time-consecutive depth frames; the current depth frame; the previous depth frame after any incorrect pixels have been marked.

The first depth range may be set such that the first depth range comprises a first set of depths, wherein a number of pixels in the frame on which setting the first depth range is based that have depth values within the first set of depths exceeds a threshold; and such that a number of pixels in the range data that have depth values within a first buffer set of depths immediately above or below the first set of depths is below the threshold.

The method may further comprise setting a second depth range that is different to, and non-overlapping with, the first depth range, wherein the second depth range is set such that: the second depth range comprises a second set of depths, wherein a number of pixels in the range data that have depth values within the second set of depths exceeds the threshold; and such that the first buffer set of depths is between the first set of depths and the second set of depths.

The first depth range may comprise the first buffer set of depths, or the second depth range comprises the first buffer set of depths, or wherein the first buffer set of depths is between the first depth range and the second depth range.

The plurality of time-consecutive depth frames may image the scene from a first viewpoint, and the method may further comprise: receiving a further plurality of time-consecutive depth frames that image the scene from a second viewpoint; receiving a further first pixel mask that identifies each of the pixels of a further current depth frame of the further plurality of time-consecutive depth frames that are likely to be imaging at least one object surface that is within a further depth range; transforming the pixels of the current depth frame correspond to the first pixel mask such that a transformed current depth frame appears to image the at least one object surface from the second viewpoint; identifying pixels of the transformed current depth frame that do not overlap with the pixels of the further first pixel mask; and marking as incorrect the pixels of the current depth frame that transform to the identified pixels of the transformed current depth frame. The first view point may be a position of a first camera of a multi-camera system that is imaging the scene, and the second view point may be a position of a second camera of the multi-camera system.

The method may further comprise generating a corrected current depth frame by correcting at least one of the pixels of the current depth frame that have been marked as incorrect.

Generating the corrected current depth frame may be based on a reference depth frame that images the scene.

The reference depth frame may be based on an earlier corrected depth frame that precedes the current corrected depth frame.

The method may further comprise: generating an updated reference depth frame using the reference depth frame and the corrected depth frame; and storing the updated reference depth frame for use in correcting a future depth frame that that follows the current depth frame in the plurality of time-consecutive depth frames.

Generating the corrected current depth frame is based on depth values of one or more neighbouring pixels that neighbour the pixels of the current depth frame that have been marked as incorrect. The one or more neighbouring pixels may all correspond to pixels identified in the first pixel mask.

In a second aspect of the present disclosure, there is provided a method for identifying in real time incorrect pixels in depth frames of a first video stream, the method comprising: receiving a first current depth frame of the first video stream; receiving a first pixel mask for the first current depth frame, wherein the first pixel mask identifies each pixel of the first current depth frame that is likely to be imaging a part of an object within a first depth range; receiving a second current depth frame of a second video stream, wherein the first video stream captures a scene from a first viewpoint and the second video stream is captures the scene from a second view point; generating a first transformed depth frame by transforming pixels of the second current depth frame such that it appears to capture the scene from the first view point; identifying pixels of the first transformed depth frame that correspond with pixels of the first pixel mask and that have a depth value that is outside of the first depth range; and marking as incorrect the pixels of the second current depth frame that transform to the identified pixels of the first transformed depth frame.

The method may further comprise: receiving a second pixel mask for the second current depth frame, wherein the second pixel mask identifies each pixel of the second current depth frame that is likely to be imaging a part of an object within a second depth range; generating a second transformed depth frame by transforming the first current depth frame such that it appears to capture the scene from the second view point; identifying pixels of the second transformed depth frame that correspond with pixels of the second pixel mask and that have a depth value that is outside of the second depth range; and marking as incorrect the pixels of the first current depth frame that transform to the identified pixels of the second transformed depth frame.

In a third aspect of the present disclosure, there is provided a method for identifying in real time incorrect pixels in depth frames of a first video stream, the method comprising: receiving a first current depth frame of the first video stream; receiving a first pixel mask for the first current depth frame, wherein the first pixel mask identifies each pixel of the first current depth frame that is likely to be imaging a part of an object within a first depth range; receiving a second current depth frame of a second video stream, wherein the first video stream captures a scene from a first viewpoint and the second video stream is captures the scene from a second view point; receiving a second pixel mask for the second current depth frame, wherein the second pixel mask identifies each pixel of the second current depth frame that is likely to be imaging a part of an object within a second depth range; generating a first transformed depth frame by transforming pixels of the first current depth frame that correspond to the first pixel mask such that it appears to capture the parts of the object that are within the first depth range from the first view point; identifying pixels of the first transformed depth frame that do not overlap with pixels of the second pixel mask; and marking as incorrect the pixels of the first current depth frame that transform to the identified pixels of the first transformed depth frame.

In a fourth aspect of the present disclosure, there is provided a computer-readable medium comprising computer executable instructions stored thereon, which when executed by one or more processors, cause the one or more processors to perform the method according to any of the first, second or third aspects.

In a fifth aspect of the present disclosure, there is provided an electronic device configured to perform the method according to any of the first, second or third aspects.

In a sixth aspect of the present disclosure, there is provided a system comprising: a first electronic device configured to perform the method according to any of the first, second or third aspects; and a second electronic device in data communication with the first electronic device over a network, wherein the second electronic device is configured to receive the output video stream from the first electronic device over the network.

In a seventh aspect of the present disclosure, there is provided a system comprising: a first electronic device configured to perform the method according to any of the first, second or third aspects; and a second electronic device in data communication with the first electronic device over a network, wherein the first electronic device is configured to receive the input video stream from the second electronic device over the network.

### DRAWINGS

Aspects of the present disclosure are described, by way of example only, with reference to the following drawings, in which:

FIG. 1 shows a functional block diagram of a video processor according to an example of the present disclosure;

FIG. 2 shows a system according to an example of the present disclosure;

FIGS. 3A and 3B show an example implementation of a depth corrector according to an example of the present disclosure;

FIG. 3C show an example alternative implementation of a depth corrector according to an example of the present disclosure;

FIG. 3D show an example further alternative implementation of a depth corrector according to an example of the present disclosure;

FIG. 4 shows an example representation of depth values in a scene;

FIG. 5A shows an example visualisation of the operation of the crude zone classifier and zone estimator of FIG. 3A;

FIG. 5B shows an example visualisation of the operation of the zone estimator of FIG. 3D;

FIGS. 6A and 6B show a functional block diagram of an example implementation of the crude zone classifier and zone estimator of FIG. 3A;

FIG. 7 shows an example visualisation of an operation of the zone store of FIG. 3B;

FIG. 8 shows a functional block diagram of an example implementation of the zone store of FIG. 3B;

FIG. 9 shows a functional block diagram of an example implementation of the depth filler of FIG. 3A;

FIG. 10 shows a functional block diagram of an example implementation of the system of FIG. 2;

FIG. 11 shows an example system for facilitating a video call;

FIG. 12 shows a system according to another example of the present disclosure;

FIG. 13 shows a system according to another example of the present disclosure;

FIG. 14 shows a system according to another example of the present disclosure; and

FIG. 15 shows a computing system according to an example of the present disclosure.

### DETAILED DESCRIPTION

To address challenges relating to the quick and efficient identification of incorrect/inaccurate pixels, a method, apparatus and computer program have been developed that uses colour frames to help identify errors in a depth frame. A scene that is imaged by a video camera is effectively divided into multiple different depth zones/ranges. A reference colour image for each depth zone/range is created using past colour frames and depth frames of the scene. Each reference colour image includes colour pixels from one or more past colour frames to create a colour image of the parts of the scene that are in the particular depth zone/range. In one example, one depth zone/range may correspond to the background of the scene, and one or more other depth zones/ranges may correspond to other distances in the scene, such as a midground depth zone/range and a foreground depth zone/range. A reference colour image for the background depth zone/range would be a colour image of the parts of the scene that are in the background depth range. Over time, the reference image for the background may be built up, for example as a person(s) in the foreground/midground moves around, until eventually the background reference image shows what most, if not all, of the background looks like.

When the latest depth frame and corresponding colour frame in the video is available, at least part of the colour frame is compared to a reference colour image to see which pixels of the latest colour frame are likely to be imaging the same parts of the scene that are imaged by the reference colour frame. In the example, the reference colour image could be the background reference colour frame. If a pixel of the latest colour frame is imaging a part of the background, the colour of that pixel should be the same or very similar to the colour of that same pixel in the background reference colour frame. If it is, then it is likely that that pixel in the latest colour frame is imaging a part of the background. If it is not, it is likely that that pixel in the latest image is imaging something that is not in the background, for example it may be imaging a person in the midground or foreground.

The pixels of the latest colour frame that are found likely to be imaging the parts of the scene imaged by the reference colour frame may be assigned to the depth zone/range of the reference colour image (for example, the background zone/range), and those pixels that are not may be assigned to a different depth zone/range (potentially after further comparisons against one or more further reference colour frames for different depth ranges). The depths of each of the pixels of the latest depth frame are then compared to the depth range assigned to the corresponding pixel of the latest colour image and the depth pixels that have a depth value outside of the assigned depth range are marked as incorrect/invalid. Subsequently, the depth pixels that are marked as incorrect/invalid may be corrected so that the accuracy of the latest depth frame may be improved.

There may be many benefits to this approach. By using reference colour images to effectively divide the latest colour and depth frame into depth zones, depth errors may be identified more accurately compared with looking at the latest depth frame alone. This may help to improve the quality and accuracy of the depth frame after correcting the identified accuracies, with, for example, reduced blurring or bleeding. Furthermore, the technique is sufficiently fast and efficient to be used for real time depth error identification and correction of a video stream (eg, identification and correction can be performed within the time between consecutive frames of a video, such as within 16 ms). This means that the approach can be used for applications such as person to person video calls/conferences.

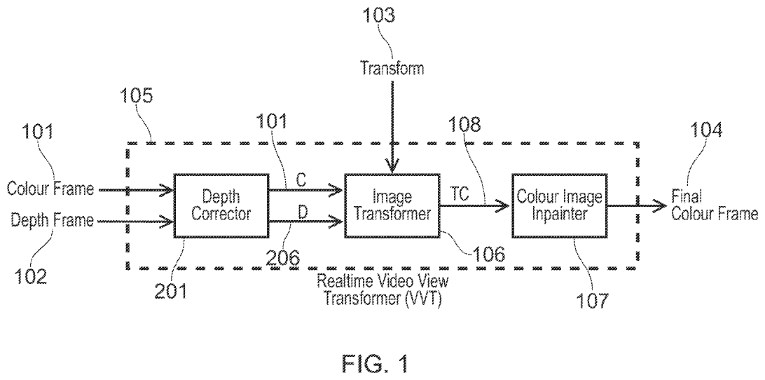

FIG. 1 shows a video processor 105 according to an example of the present disclosure. The video processor 105 receives an image comprising a colour frame 101 and/or a depth frame/data 102. The colour frame 101 may be part of an input video stream captured by a (real) camera. The video processor 105 also receives transformation data 103. The depth frame 102 may be considered as a depth image or depth map. The transformation data 103 may be considered as a transformation matrix. The video processor 105 is configured to generate an output image 104 based on the input image (the colour frame 101 and/or the depth frame 102) and the transformation data 103. The output image 104 may show the scene captured in the input image from the perspective of a (virtual) camera that is in a different position relative to the real camera. The output image 104 may be considered as an estimation of the scene from the perspective of the virtual camera.

The colour frame 101 has a size of a particular width of pixels x_{MAX} in the horizontal direction and a particular height of pixels y_{MAX} in the vertical direction. The colour frame 101 can therefore be considered as a 2D grid of pixels having a coordinate system [0, x_{MAX}], [0, y_{MAX}]. Individual pixels in the colour frame 101 can be uniquely identified by a pair of pixel coordinates (x, y). The x values are integers ranging from 0 to x_{MAX} in the horizontal direction (or along an x axis of the image) and the y values are integers ranging from 0 to y_{MAX} in the vertical direction (along a y axis of the image). Each pixel may be considered as a discrete location in the colour frame 101 that is capable of displaying a colour (e.g. based on RGB values, or a greyscale value, or any other suitable way of representing the visual appearance of the captured scene). As such, each pixel is also associated with a pixel value V(x, y). For example, each pixel value V may have a R (red) component, G (green) component and B (blue) component, which in combination determine the colour of the pixel. Alternatively, the pixel value V(x, y) may be a greyscale value which indicates the colour (in this case the grey level) of the pixel. The pixel coordinate (x, y) corresponds to the discrete location of the image grid in which the associated pixel value V(x, y) (i.e. colour) should be generated and displayed. Each pixel may be considered as having a pixel size made up of a pixel width in the x direction and a pixel height in the y direction. For simplicity, the pixel width and height may be considered as being one integer, such that each pixel occupies a 1×1 area of the 2D image grid.

The depth frame 102 includes a depth value d(x, y) for each pixel (x, y) of the image 101. The depth value d(x, y) indicates the depth of the respective pixel (x, y) of the image 101, e.g. from the perspective or view of the real camera. The depth value d(x, y) may be considered as a distance from the real camera of the thing (i.e., the object surface) that is imaged by the pixel (x, y). Similarly to the colour frame 101, the depth frame 102 will have a size of a particular width of pixels x_{MAX} in the horizontal direction and a particular height of pixels y_{MAX} in the vertical direction. The depth frame 102 can therefore be considered as a 2D grid of pixels having a coordinate system [0, x_{MAX}], [0, y_{MAX}]. Individual pixels in the depth frame 102 can be uniquely identified by a pair of pixel coordinates (x, y). The x values are integers ranging from 0 to x_{MAX} in the horizontal direction (or along an x axis of the image) and the y values are integers ranging from 0 to y_{MAX} in the vertical direction (along a y axis of the image). Each depth pixel may be considered as a discrete location in the depth frame 102 that is associated with a depth value d(x, y). The depth frame 102 may be visually displayed as a greyscale image. Similarly to the colour frame 101, the pixel coordinate (x, y) corresponds to the discrete location of the image grid in which the associated pixel value d(x, y) (i.e. depth) should be generated and displayed. Each pixel may be considered as having a pixel size made up of a pixel width in the x direction and a pixel height in the y direction. For simplicity, the pixel width and height may be considered as being one integer, such that each pixel occupies a 1×1 area of the 2D image grid.

The transformation data 103 is indicative of a 3D transformation between the position of the real camera and the position of a virtual camera relative to the scene. As such, the transformation data 103 indicates the desired change in view of the input video stream. The transformation data 103 may be represented as a mathematical function. The transformation data 103 may correspond to a 3D transformation matrix. The transformation data 103 may include parameters indicative of the change in the 3D translational and/or 3D rotational position between the real camera and the virtual camera. In particular, the transformation data 103 may include translation parameters indicative of a change in a 3D translational position between the real camera and the virtual camera in 3D space. The transformation data 103 may also include rotation parameters indicative of a change in a 3D rotational position between the real camera and the virtual camera in 3D space.

The video processor 105 is configured to generate an output image 104 based on the input colour frame 101 and depth frame 102, and the transformation matrix 103. The output colour frame 104 will show the scene captured in the input image, but from the perspective of the virtual camera instead of the perspective of the real camera. The output colour frame 104 estimates the scene from the perspective of the virtual camera. For simplicity, the output image 104 may be considered as having the same size as the image 101, and therefore the same number of pixels.

The video processor 105 may include an image transformation module/unit 106 (i.e. an image transformer, also referred to as a 3D view transformer) which receives the colour frame 101, depth frame 102, and the transformation matrix 103. The image transformer 106 processes the colour frame 101 based on the depth frame 102 and the transformation matrix 103 to generate a transformed image 108. The image transformer 106 may also use camera parameters of the real camera to generate the transformed image 108, such as the focal length and/or the centre point of the real camera. The transformed image 108 shows the scene captured in the colour frame 101, but from the perspective of the virtual camera. The transformed image 108 may have the same size and dimensions as the colour frame 101.

Due to the change in position between the real camera and the virtual camera, the transformed image 108 may include gaps or holes, i.e. regions of undefined pixels, or pixels without assigned values. Said pixels may be considered as a type of erroneous pixel, in particular missing pixels. The missing pixels may correspond to parts of the scene that the real camera was originally unable to see. As such, the video processor 105 may further include an inpainter 107, which may also be considered as a filler 107. The inpainter 107 is configured to inpaint the transformed image 108. The inpainter 107 receives the transformed image 108 and corrects the erroneous pixels. In particular, the inpainter 107 may assign values (i.e. colour) to the missing pixels. The operation of the image transformer 106 and the colour inpainter 107 are not the focus of the present disclosure, so their detailed operation shall not be described any further.

The focus of the present disclosure is the depth correction (or depth cleanup) function 201. In some scenarios, the depth frame 102 may not be accurate (e.g. it may have incorrect depth values at some pixel locations). The depth corrector 201 is configured to identify incorrect depth values in the depth frame 102 and optionally correct at least some of the identified incorrect depth values. The depth corrector 201 receives the depth frame 102 and the colour frame 101 and outputs the colour frame 101 and a modified depth frame 206. The modified depth frame 206 corresponds to the depth image 102 but with the identified inaccurate/incorrect pixels either marked (for example, deleted so that the pixel has no value) or corrected (for example, the inaccurate/incorrect depth value replaced with a more accurate/correct depth value). As such, the depth corrector 201 may reduce inaccuracies in the depth frame 102. This in turn should improve the accuracy of the operation of the image transformer 106 so that the final colour frame 104 is a better representation of the scene from the perspective of the virtual camera.

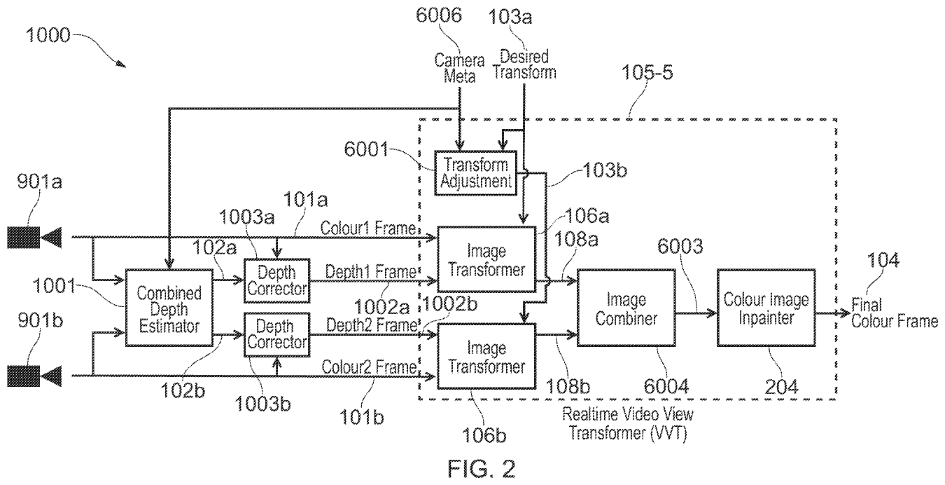

FIG. 2 shows a system 1000 according to an example of the present disclosure. The system 1000 includes a video processor 105-5 according to an example of the present disclosure. The video processor 105-5 is configured to combine images from two video streams in order to form the final output image 104.

The video processor 105-5 includes a first channel “a” and a second channel “b”. The first channel receives a colour frame 101a of a first input video stream captured by a first real camera (i.e. camera 901a), and a corresponding depth frame 1002a. Furthermore, the second channel receives a colour frame 101b of a second input video stream, and a corresponding depth frame 1002b. The second video input stream is captured by a second real camera (i.e. camera 901b). The second real camera is positioned to capture the same scene or environment as the first real camera, but at a different position or angle to the first real camera. For example, if the scene includes a human subject in a video call setting, the first real camera 901a may be positioned to capture more of the left side of the human's face and the second real camera 901b may be positioned to capture more of the right side of the human's face. As such, the colour frames 101b of the second input stream are related to the frames 101a of the first input stream, in the sense that they show the same scene but from a different angle or perspective. Moreover, it will be appreciated that the first and the second real cameras may capture images at the same frame rates, and approximately at the same points in time.

Each of the first channel and the second channel include an image transformation module/unit 106a and 106b, respectively. The image transformation modules 106a and 106b function similarly to the image transformation 106 described previously.

The image transformation module 106a may receive first transformation data 103a, which is indicative of a transformation between the position of the first real camera and the position of the virtual camera relative to the scene. The first transformation data 103a may be characterised and function similarly to the transformation data 103 described previously. Consequently, the image transformation module/unit 106a generates a first transformed image 108a which shows the scene captured in the colour frame 101a from the perspective of the virtual camera.

The image transformation module 106b may not use the first transformation data 103a used in the first channel, because the colour frame 101b is captured using the second real camera that is in a different position to the first real camera. As such, the video processor 105-5 may include a transform adjustment block 6001. The transform adjustment block 6001 receives the first transformation data 103a. The transform adjustment block 6001 processes or transforms the first transformation data 103a to generate second transformation data 103b. The second transformation data 103b is indicative of a transformation between the position of the second real camera 901b and the position of the same virtual camera relative to the scene. As such, the second transformation data 103b can be used by the second channel. The second transformation data 103b can be generated using camera metadata 6006 which is received by the transform adjustment block 6001. The camera metadata 6006 is indicative of the relative position between the first and second real cameras. The transform adjustment block 6001 may transform the transformation data 103a based on the camera metadata 6006 to generate the second transformation data 103b. Consequently, the image transformation module 106b may be able to generate a second transformed image 108b, which shows the scene captured in the image 101b from the perspective of the same virtual camera. The first transformed image 108a and the second transformed image 108b are different estimates of the scene from the perspective of the virtual camera. The image transformation module 106b may use camera parameters of the second real camera to transform the pixel coordinate, such as the focal length and/or the centre point of the second real camera.

Since the first real camera 901a and the second real camera 901b capture the same scene from different angles, some areas of the scene may be better visible to the second real camera 901b or the first real camera 901a. As such, the first transformed image 108a and the second transformed image 108b may be combined by an image combiner 6004 to generate a more complete and higher quality combined image 6003.

It will be appreciated that although only two channels are shown in FIG. 2, more than two channels are also envisaged. For example, additional channels may receive additional video streams from additional cameras and process the video streams in a similar way to the first and the second channels described above, and the image combiner 6004 may generate the image 6003 further based on the additional transformed pixel data generated by the additional channels (e.g. by selecting the pixel with the highest quality score, or blending the pixels proportionally to the quality score).

The first and second real cameras 901a and 901b may be set up as follows. For example, with a subject sitting in front of and using a typical 24-28 inch display unit (e.g. monitor), it may be desired to position the virtual camera anywhere across a 40 cm distance in the x direction. As such, the real cameras can be set up on either side of the 40 cm space to capture the scene from different angles. As a result, the real cameras will capture sufficient image content to generate the final output image 104, whilst putting less burden on the inpainter 204.

It will be appreciated that the cameras can be arranged independently of one another and belong to different electronic devices (e.g., different webcam units or video conferencing cameras). For example, the cameras can be positioned in a meeting room to capture attendees from different angles.

It will be appreciated that the positioning of the first and second real cameras 901a and 901b may differ from a pair of stereo cameras. Stereo cameras may be placed intentionally close to one another, to capture the scene from almost the same angle in order to determine the depth of the scene. However, the first and second real cameras may be placed at a greater distance apart, in order to capture the same scene from different angles and/or positions, so that each camera may intentionally capture different views of the scene.

The operation of the video processor 105-5 is not the focus of the present disclosure, so its detailed operation shall not be described any further.

FIG. 2 further shows how the colour frame outputs of the first and the second cameras 901a and 901b may be used to determine the corresponding depth frames 102a and 102b for each channel. As described previously, the cameras 901a and 901b may be spaced at a sufficient distance apart (e.g. at the extremities of the region in the scene where the virtual camera is likely to be placed), in order to capture more pixel data of the scene. As a result, although the cameras 901a and 901b capture the same scene from different angles, the images captured by the cameras 901a an 901b will not contain the same parts of the scene. Rather, there may be significant parts of the colour frame 101a that are not present in the colour frame 101b. As such, stereo depth estimation techniques may not be suitable to determine the complete depth frames from the outputs of the cameras 901a and 901b.

The system 1000 may therefore include a depth estimator 1001 which receives each of the colour frames 101a and 101b. The depth estimator 1001 may also receive the camera metadata 6006, which indicates the relative positions of the cameras 901a and 901b as described above. The depth estimator 1001 may generate depth frame 102a and depth frame 102b based on the colour frames 101a and 101b, and the camera metadata 6006.

Using the camera metadata 6006, the depth estimator 1001 may identify pairs of pixels of the colour frames 101a and 101b that correspond to the same location in the scene. In particular, for each pixel of the colour frame 101a, the depth estimator 1001 may determine whether there is a corresponding pixel in the colour frame 101b that captures the same location within the scene. The corresponding pixel may have a different coordinate to the pixel of the colour frame 101a. The depth estimator 1001 may make this determination based on the camera metadata 6006. If a corresponding pair of pixels is found, then the depth estimator 1001 may determine the depth of the pixel in the colour frame 101a based on the difference between the coordinate of the pixel in the colour frame 101a and the coordinate of the corresponding pixel in the colour frame 101b. Furthermore, the depth of the corresponding pixel in the colour frame 101b may also be determined in similar way. The depth estimator 1001 may output the depth frame 102a which includes the depths of the pixels of the colour frame 101a for which a corresponding pixel was found. Furthermore, the depth estimator 1001 may output the depth frame 102b which includes the depths of the corresponding pixels of the colour frame 101b.

It will be appreciated that each of the depth frames 102a and 102b may each include some errors or inaccuracies, since the combined depth estimator 1001 is unlikely to estimate depths perfectly based on the colour frames 101a and 101b. Therefore, a depth corrector 1003a may be used to identify incorrect/inaccurate depth pixels in the depth frame 102a and output a modified depth frame 1002a, which is then used by the two-channel video processor 105-5. Likewise, a depth corrector 1003b may be used to identify incorrect/inaccurate depth pixels in the depth frame 102b and output a modified depth frame 1002b, which is then used by the two-channel video processor 105-5. Each of the depth correctors 1003a and 1003b may be implemented and operate in the same way as the depth corrector 201 described with reference to FIG. 1. The operation of the depth corrector(s) is the focus of this disclosure and shall be described in more detail below.

Advantageously, the system 1000 does not require any dedicated hardware (e.g. stereo camera pairs or time of flight units) in order to determine the depths of each pixel in the colour frames 101a and 101b. Rather, the two-camera setup 901a and 901b can be used to determine the depth values, whilst achieving the advantages of the two-channel video processor 105-5.

Optionally, the video processor 105-5 may be modified to only use the colour frames and depth frames from one source camera, for example 101a and 1002a, and either ignore, or not receive, the colour frame and depth frame from the other source camera, for example 101b and 1002b. In such arrangement, the depth estimation 1001 may use the colour frames 101a and 101b from both cameras 901a and 901b as shown in FIG. 2. Optionally, depth correction may be conducted on only one depth frame, for example 102a, and the other depth corrector 1003b may be omitted. In this case, the view transformer 105-5 may be configured in the same way as any of the view transformer shown in FIG. 1.

It will be appreciated that in each example depth corrector disclosed herein, the colour frame 101 and depth frame 102 received by the depth corrector will be a current or latest colour frame 101 and depth frame 102 of a plurality of time consecutive frames that together form a video. As a result, the depth corrector will periodically receive new colour and depth frames at an interval determined by the frame rate of the video camera (for example, if the frame rate is 24Hz or 24 fps, a new frame will be received approximately every 42 ms, and if the frame rate is 60 Hz or 60 fps, a new frame will be received approximately every 16.7 ms, etc). Therefore, in order for the depth corrector to be operable in real-time (for example, operating on a video feed from a participant in a video call or video conference) it must complete its operations within the inter-frame time interval of the video camera(s), for example in 42 ms or faster, or in 16.7 ms or faster. The depth corrector of this disclosure has been designed to fulfil this requirement.

Furthermore, whilst FIGS. 1 and 2 suggest a particular use for the modified depth frames output by the depth corrector, it will be appreciated that the depth corrector disclosed herein could be used for any purpose or application. For example, it may be used to generate and output modified depth frames that are subsequently used for any other purpose.

Finally, it should be appreciated that the depth frames received by the depth corrector disclosed herein may be generated in any suitable way, such as using the technique represented in FIG. 2, or using a Time of Flight (ToF) system, or a LIDAR system, etc. Regardless of how the depth frames are determined, the depth corrector is configured to identify inaccurate/incorrect pixels, and optionally also correct them, in the same way.

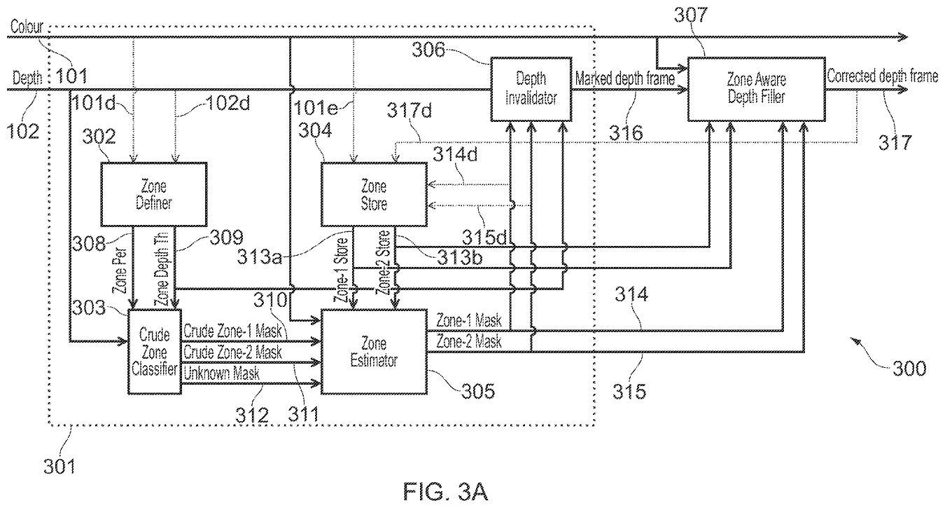

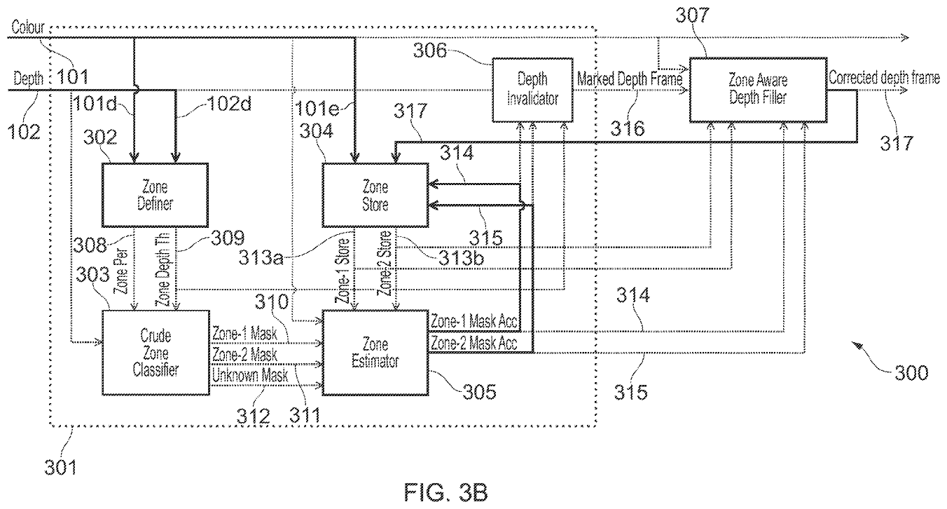

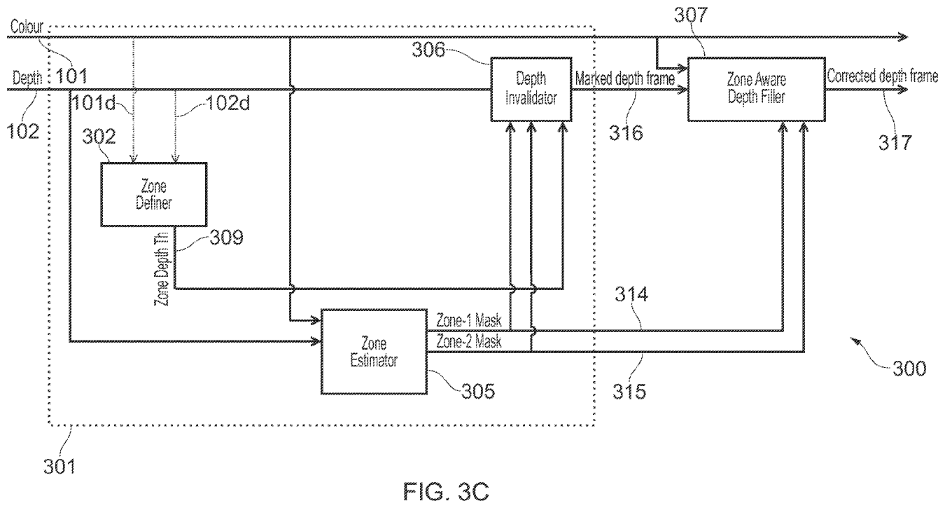

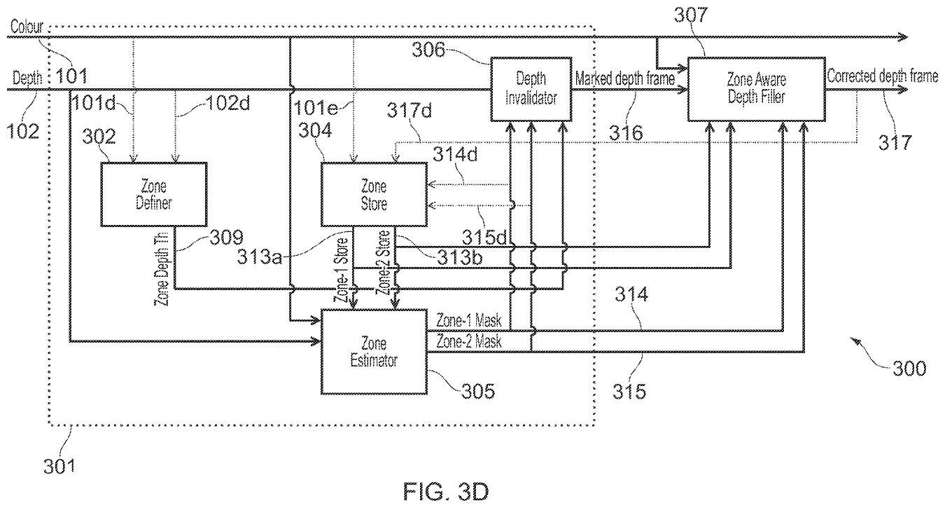

FIG. 3A show an example schematic representation of a depth corrector 300, which may be used as the depth corrector 201 or 1003a/b described earlier. The representation in FIG. 3A shows the depth corrector 300 in a first state, in which errors/inaccuracies in the received depth frame 102 are identified by the error identifier 301 and then corrected by the depth filler 307 to generate a modified depth frame, eg the corrected depth frame 317 that is output from the depth corrector 300. The corrected depth frame 317 corresponds to the depth frames 206 and 1002a/b in FIGS. 1 and 2.

FIG. 3B shows the same depth corrector 300 as is represented in FIG. 3A, except that it represents its operation in a second state. In the second state, after the corrected depth frame 317 has been generated, the zone definer 302 and the zone store 304 are updated.

FIG. 3C shows an alternative implementation of the depth corrector 300, which is similar to that of FIG. 3A but does not include a Crude Zone Classifier 303 or Zone Store 304.

FIG. 3D shows a further alternative implementation of the depth corrector 300, which is similar to that of FIG. 3A but does not include a Crude Zone Classifier 303. Operation of this example implementation in the second state is the same as that represented in FIG. 3B.

Returning to FIG. 3A, the depth corrector 300 comprises an error identifier 301 that receives a colour frame 101 and a depth frame 102. The received colour and depth frames are the current (or latest) frames in a plurality of time consecutive colour and depth frames that image a scene (which will contain one or more objects. In the context of this disclosure, an object can be any visible thing within the scene, for example a person, a wall, a floor, a ceiling, an inanimate object, etc). The error identifier comprises a zone definer 302 that is configured to set the boundaries, or limits, of at least a first depth range and a second depth range. For example, the first depth range may be for the background of the imaged scene and may be, for example, 2.4 m to 5 m, and the second depth range may be for the foreground of the imaged scene and may be, for example, 0.3 m to 1.2 m. Each depth range set by the zone definer will be different to, and non-overlapping with, the other depth range(s) set by the zone definer. The zone definer 302 may optionally set the boundaries, or limits, for more than two depth ranges, such as three depth ranges, four depth ranges, etc. However, for the sake of simplicity, we shall typically description the system operation with reference to two depth ranges, usually representing a background depth range and a foreground depth range. The depth ranges may sometimes we referred to interchangeably as “depth zones” or “zones”, such that a first depth range may also be referred to as “depth zone 1” or “zone 1”.

The depth ranges set by the zone definer 302 may be set using previous, or earlier, depth frames (and optionally also colour frames) that precede the current frame in the plurality of time-consecutive frames. The depth ranges set by the zone definer 302 may be updated using the current depth frame 102 and colour frame 101, and/or the marked depth frame 316 and/or the corrected depth frame 317 when the depth corrector 300 is operating in the second state, which will be described in more detail later.

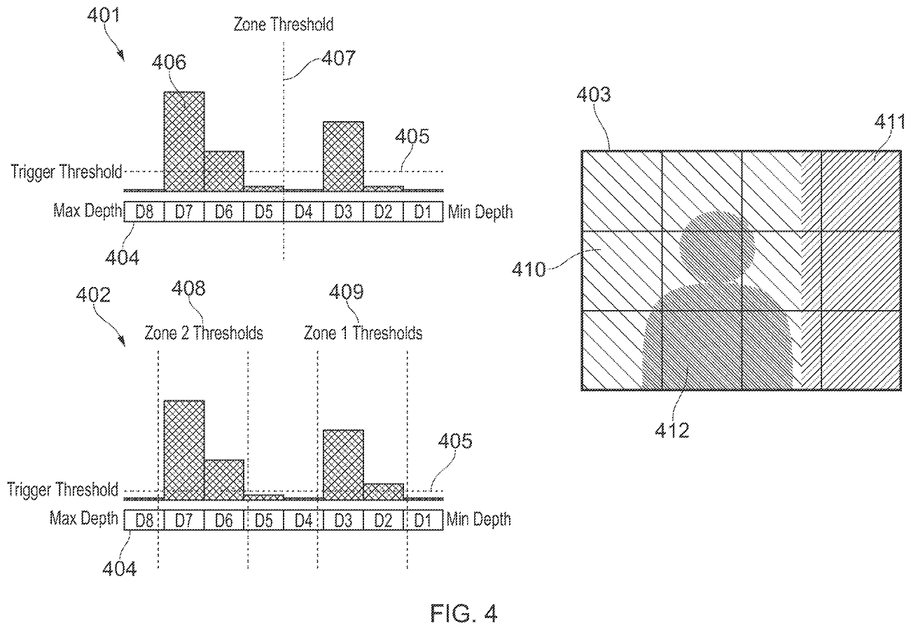

FIG. 4 shows an example depth frame 403 of a scene 403 to help explain the depth ranges and the operation of the zone definer 302. The scene includes a person 412 who is relatively close to the camera, a wall 410 that is relatively far from the camera and something else, such as another wall or bookcase, that is at a depth between the person 412 and the wall 410. In this example the depth map is divided into twelve areas, which is one example of dividing the depth map into areas.

The zone definer 302 may be configured to identify and define ranges of depth in which significant numbers of depth pixels in the depth frames are likely to fall. This may be better understood by considering the scene 403 and example depth buckets. For example, an expected full range of the scene, for example 0.2 m to 5 m, may be divided into any number of depth buckets 404 (in the examples of 401 and 402, there are eight buckets, D1-D8). Each bucket represents a sub-range of the full range of the scene, for example D1 may be 0.2-0.8 m, D2 may be 0.8-1.4 m, etc. A count of the number of pixels of the depth frame having a depth value within each depth bucket may be determined, and is represented by the histogram bars 406. In the example of 401 and 402, there are large numbers of pixels having a depth value within buckets D3 (likely imaging the person 412) and D6 and D7 (likely imaging the wall 410 and bookcase 411). The zone definer 302 may set the limits of the depth ranges so that each depth range encompasses a significant range of depths within the scene. For example, one significant range of depths may be that of D3, and another significant range of depths may be that of D6 and D7. Therefore, in the example 401 the zone definer 302 sets a threshold 407 that defines the first depth range and the second depth range, wherein the first depth range covers depths up to the threshold 407 (in this example depths from 0 m to 2.6 m-eg, foreground depths) and the second depth range covers depths that are greater than the threshold (in this example, depths that are greater than 2.6 m-eg background depths). In the example of 402 the first and second depth ranges are set differently, with thresholds that define the upper and lower limits of each of the first 409 and second 408 depth ranges.

The zone definer 302 may identify significant ranges of depths within the depth frame in any suitable way. In this example, it uses a trigger threshold 405, which helps it to identify and define a safe division between zones. For example, it can be seen in examples 401 and 402 that the depth bucket D3 has a number of pixels that exceed the trigger threshold (eg, the total number of pixels having a depth value within the range defined by D3 is greater than the trigger threshold). Therefore, the range defined by D3 (in this example 1.4 m-2 m) may represent a first set of depths. The depth buckets D4 and D5 each have a number of pixels that are less than the trigger threshold (eg, the total number of pixels having a depth value within the range defined by each of D4 and D5 is less than the trigger threshold). Therefore, the range defined by D4 and D5 (in this example 2 m-3.2 m) may represent a first buffer set of depths. The depth buckets D6 and D7 each have a number of pixels that exceed the trigger threshold (eg, the total number of pixels having a depth value within the range defined by each of D6 and D7 is greater than the trigger threshold). Therefore, the range defined by D6 and D7 (in this example 3.2 m-4.4 m) may represent a second set of depths. Therefore, two ranges of depth values have been identified (the first and second sets of depths), within each of each a significant number of depth pixels are likely to fall, and that are separated by a first buffer set of depths. Therefore, by setting the first and second depth ranges to comprise the first and second sets of depths respectively, it is expected that the vast majority of current frame pixels can be correctly assigned to the first or second depth range with very limited error or ambiguity. Therefore, each depth range may be set by looking for a set of depths within which the number of pixels exceeds the trigger threshold, and that has an adjacent buffer set of depths immediately above or below the set of depths (and buffering the set of depths from any other identified sets of depths that may form part of other depth ranges).

The first depth range may be set to comprise the first set of depths and at least part of the first buffer set, and the second depth range may be set to comprise the second set of depths and at least part of the second buffer set. This can be seen, for example, in the graphic 401, wherein the zone threshold 407 is set such that the first depth range is for all depth values up to 2.6 m, which comprises the first set of depths (1.4 m-2.0 m) and also part of the first buffer set, in particular 2.0-2.6 m. The second depth range is for all depth values over 2.6 m, which comprises the second set of depths (3.2 m-4.4 m) and also part of the first buffer set, in particular 2.6 m-3.2 m. It can also be seen in the example of graphic 402, where the zone thresholds are set such that the first depth range comprises the first set of depths (1.4 m-2.0 m) and optionally also a part of the first buffer set, such as 2.0-2.1 m. The zone thresholds are also set so that the second depth range comprises the second set of depths (3.2 m-4.4 m) and optionally also part of the first buffer set, such as 3.1-3.2 m.

The trigger threshold may be set to any suitable value, for example in consideration of the number of pixels in the depth frame. For example, it may be set to 100, or 150, or 200 pixels if the depth frame comprises a typical 1280 by 720 pixels (921,600 pixels in total).

Whilst one particular example of setting depth ranges by counting the number of depth values falling within particular buckets is described above, any suitable alternative approach may be used in order to set depth ranges that each comprise a set of depths in which the number of pixels exceeds a trigger threshold, and that has at least one adjacent buffer set of depths. For example, a neural network may be used that is trained to identify significant depth ranges in the scene imaged by the depth frames 102 that also have at least one adjacent buffer set (in particular that an adjacent buffer(s) set that separates the significant depth range from the next significant depth range(s)).

The zone definer 302 may set third, fourth, etc depth ranges in the same way, each encompassing a range of depths that have been determined to be significant, as explained above.

As mentioned earlier, the scene may be divided into a number of areas (12 areas in the example scene 403). Each area may have two or more different depth ranges that are independent of the depth ranges that are set for the other areas. This may enable more effective depth ranges to be set. In the example scene 403, the zone definer 302 has set areas of equal size and shape. However, it may alternatively set the areas dynamically based on the content of the depth frames, such that each area may be of any size and shape.

In an alternative, the entire scene captured by the frame may be a single area. In the rest of this disclosure, for the sake of simplicity, the operation of the depth corrector 300 is described as if the scene is not divided into multiple different areas, each with their own depth ranges and instead assumes that there is a single area covering the entire scene. However, if the scene is divided into two or more areas, the frame processing operations described herein are repeated for each area. As a result, in the context of the processes described herein, “a frame” may be thought of as an area of the imaged scene, which may be the entire imaged scene, or may be one area of the imaged scene, the boundaries of which may be set by the zone definer 302.

Other functions of the error identifier 301 will need to know the boundaries of the depth ranges set by the zone definer 302, but on initial start up of the system, there will be no prior knowledge of the scene being imaged by the video camera. Therefore, initially the zone definer 302 may set the depth ranges based on the content of the first depth frame 102 that the error identifier 301 receives. Subsequently, the boundaries of those zones may be updated and refined using subsequent depth frames 102 and/or modified depth frames (such as marked depth frames 316 and/or corrected depth frames 317). This will be described in more detail later, in the context of operating in the second state represented in FIG. 3B.

The zone definer 302 outputs an identification of the depth ranges it has set (eg, the first and second depth ranges), for example as one or more zone depth thresholds 309. Optionally, it also outputs an identification 308 of the pixels that are included in the area to which the zone depth thresholds 309 correspond. In this case, each area identified by data 308 may have one or more associated zone depth thresholds that are indicative of the depth ranges for that area.

Returning to FIG. 3A, the error identifier 301 may optionally have a crude zone classifier 303 that receives the current depth frame 102 and the thresholds of the depth ranges 309 (and optionally also the area identification 308). The purpose of the crude zone classifier 303 is to reduce the extent of colour frame comparison required of the zone estimator 305, which may improve efficiency and speed. In this example implementation, the crude zone classifier 303 may do a basic comparison of the depth values of the pixels in the current depth frame 102 against the depth ranges. For example, for each pixel in the depth frame 102 that has a depth value (it is quite common for some depth pixels to be missing a depth value) it may determine if the depth value is in the depth range of zone 1, or zone 2, or any other zone set by the depth threshold(s) 309. Based on that, an area of uncertainty for each zone may be determined for further processing and refinement.

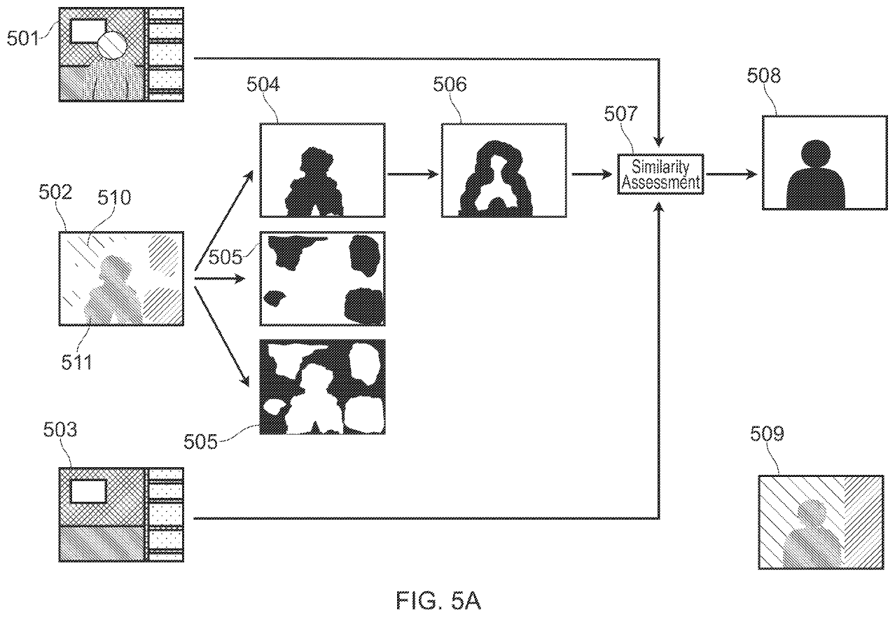

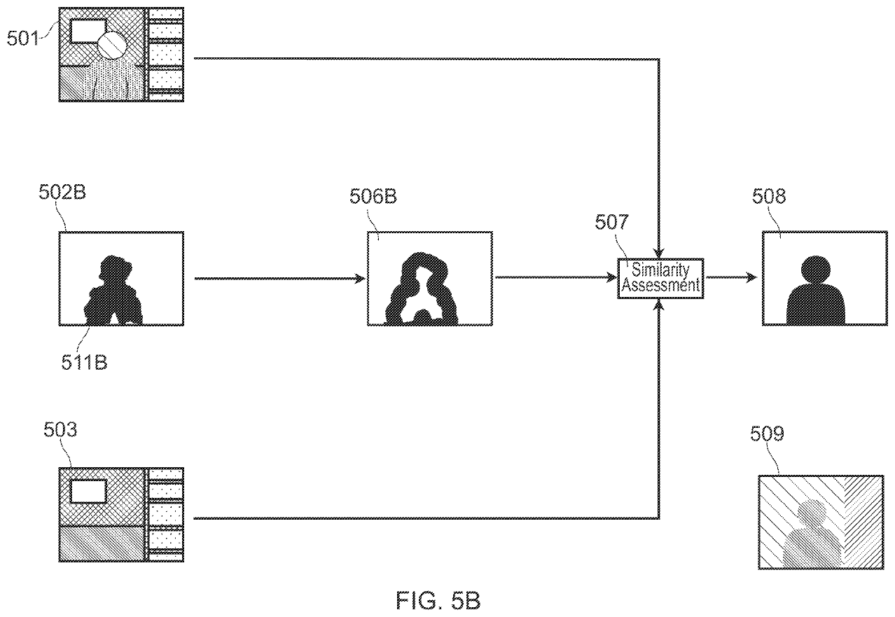

FIG. 5A show a visualisation that may help in understanding the operation of the crude zone classifier 303 and how the crude depth zones determined by the crude zone classifier 303 are used by the zone estimator 305. Reference 502 shows a visualisation of the current depth frame. The shading represents the depth value at each pixel, with pixels that are imaging a surface in the scene that is closer (eg, lower depth) being represented by the shading 511 and pixels that are imaging a surface in the scene that is further away (eg, greater depth) being represented by shading 510. Much of the frame is white, which are pixels having no depth value. For reference, image 509 in the bottom right of FIG. 5A shows what a perfect depth frame of the scene would look like.

The crude zone classifier 303 may identify depth pixels having a depth value that is within the range of zone 1 (in this example, the foreground depth range). These are represented by image 504. The crude zone classifier 303 may communicate the identified pixels as a crude zone 1 pixel mask 310. A pixel mask may be thought of as a 2D array, where each position represents a pixel of the colour/depth frame. The value of each position in the pixel mask is either true or false (eg, either 1 or 0), indicating whether or not the corresponding pixel of the colour/depth frame belongs to that mask. So, for the crude zone 1 pixel mask 310, each mask pixel that is marked as true indicates that the corresponding pixel of the colour/depth frame is thought to be imaging a part of a surface that is within the first depth range. Therefore, image 504 in FIG. 5A is a representation of the crude zone 1 pixel mask 310, where all black points indicate pixels of the depth frame that are thought to be imaging a surface in the first depth range (in this example, a surface in the foreground).

The crude classifier 303 likewise does the same for zone 2, generating and outputting a crude zone 2 pixel mask 311 that identifies each pixel of the depth frame that this thought to be imaging a surface that is within the second depth range (in this example, a surface in the background, in this example), and for any other depth zones set by the zone definer 302. Image 505 in FIG. 5A is a representation of the crude zone 2 pixel mask 311, where all black points indicate pixels of the depth frame that are thought to be imaging a surface in the second depth range.

Optionally, the crude classifier 303 may also generate and output an unknown mask 312 that identifies each pixel of the depth frame that is not in any of the defined zones (typically, this mask may indicate pixels for which depth values are missing). Image 506 in FIG. 5A is a representation of the unknown mask 312, where all black points indicate pixels that are not thought to belong to any of the defined zones (in this example, pixels that are not thought to belong to either zone 1 or zone 2).

As mentioned earlier, the crude zone classifier 303 is optional and FIG. 3D shows an alternative implementation where the crude zone classifier is omitted. In this example, rather than receiving and using masks from the crude zone classifier 303, the zone estimator 305 may simply receive and use the current colour frame 101 and/or the current depth frame 102 to perform its operations.

The zone estimator 305 is configured to compare at least a part of the current colour frame 101 against a reference colour frame 313 in order to generate a pixel mask 314, 315 for each of the depth zones. The generated pixel masks 314, 315 may be thought of as a refinement or improvement of the crude zone masks 310, 311.

In the example where there is a crude zone classifier 303 (FIG. 3A), the zone estimator 305 may use the crude zone masks 310, 311 to limit the amount of comparison that it needs to perform, so that only a part of the current colour frame 101 is compared against a reference colour frame. For example, returning to FIG. 5A, for zone 1 the zone estimator 305 may take the crude zone 1 pixel mask 310 and determine an area of uncertainty, which is represented by the black area in image 506. In this example, the area of uncertainty is all around the boundary of the region that the crude zone classifier 303 thought was part of zone 1. The area of uncertainty may be determined, for example, by dilating and eroding black area in image 504 and then subtracting one from the other. Everything within the area of uncertainty (eg, the white area surrounded by the black area in image 506) may be seen as an area of high confidence where it is considered likely that the pixels of the depth frame are imaging a surface that is within the first depth range. All of the black area in image 506 represents the part of the frame on which the colour comparison will be performed (explained in more detail later).

It will be appreciated that this is merely one example of how areas of uncertainty (and optionally also areas of high-confidence) may be determined using the current depth frame 102. However, it will be appreciated that it may be determined using the current depth frame 102 in any other way. For example, the zone estimator 305 may additionally or alternatively look for groupings of pixels in the current depth frame 102 that have relatively consistent depth values within the zone 1 depth range and classify those as an area of high-confidence, and look for groupings of pixels where some have depth values within the zone 1 depth range and others do not, and classify those as an area of uncertainty. For example, the groupings may be required to have a minimum size, for example at least five, 10, 15, 20, etc adjacent pixels all having similar depth values (for example, all within 2%, or 5%, or 10%, etc, of each other). Additionally or alternatively, a neural network may be used, which may be trained to use the current depth frame 102 to identify areas of the frame where there is uncertainty whether the frame is imaging something (eg, a part of a surface) in zone 1 or not, and identify other areas of the frame where there is high confidence of imaging something in zone 1.

In a further alternative, the zone estimator 305 may simply perform the colour comparison on the frame area identified by the crude zone 1 pixel mask 310 (eg, the black area in image 504). In a further alternative, where there is no crude zone classifier 303 (the example of FIG. 3D), the zone estimator 305 may simply perform the colour comparison across the whole area of the current colour frame 101, or may limit the area of comparison in some other way (as explained later).

FIG. 5A shows a representation of the colour comparison that is performed by the zone estimator 305 of FIG. 3A, which is represented with reference 507. The colour comparison is performed using the current colour frame 101 (represented as image 501 in FIG. 5A) and a reference colour frame (represented as image 503 in FIG. 5A). The reference colour frame is obtained by the zone estimator 305 from a zone store 304, which may comprise, for example, a database or a memory, such as volatile or non-volatile memory. In the example of FIG. 3A, the zone store 304 is part of the error identifier 301, but in an alternative at least part of it may be an external storage device that is accessible to the error identifier 301. In the example of FIG. 5A, the reference colour frame is an image of the background of the scene (depth zone 2 in this particular example), and is the zone 2 reference colour frame that is part of the zone-2 stored reference frames 313b of FIG. 3B (for each zone, the zone store 304 may store a reference colour frame and a reference depth frame. The zone estimator 305 may receive and use the reference colour frame for at least one of the depth ranges in order to generate the zone marks 314,315).

The reference colour frame is made up of pixels from one or more previous colour frames that precede the current colour frame in the plurality of time-consecutive colour frames (likewise, the reference depth frames stored by the zone store 304 are made up of pixels from one or more previous depth frames-which may include one or more depth frames 102, and/or one or more marked depth frames 316, and/or one or more modified depth frames 317). Over time, different parts of the zone represented by the reference colour frame may become visible in the colour frames 101, and the reference colour frame may be a composite representation that the error identifier 301 has built up over time. For example, considering the background zone shown in image 503, at any given time a part of the background may not be visible because a person is in the way. However, over time the person may move and reveal parts of the background. The error identifier 301 is configured to build up the detail of the background reference colour frame by adding additional part of the background to the reference colour frame as they are revealed (as explained in more detail later). The same is also true for the reference depth frame for each depth zone.

Based on a comparison of the part of the current colour frame 101/501 corresponding to the area of uncertainty (image 506 in FIG. 5A) to the reference colour frame 313/503, the zone estimator 305 determines a first pixel mask for the first depth range (in this particular example, the foreground depth range) 314. The determined depth mask is visualised by image 508 in FIG. 5A. The first pixel mask 314 identifies each of the pixels of the current colour frame 101/501 that are determined by the colour comparison to be likely to be imaging at least one part/location/object surface of the scene that is within the first depth range (and in this example also the pixels corresponding to the area of high confidence). In the particular example of image 508, it can be seen that the first depth mask 314 identifies the object surfaces (eg, the person) in the foreground of the scene. As can be seen by also considering the images 502, 504 and 509, the first pixel mask 314 identifies the parts of the scene that are within the first depth range more accurately than the current depth frame 102/502 and the crude zone 1 pixel mask 310/504.

FIG. 5B shows one example implementation of the zone estimator 305 of FIG. 3D. In this example, rather than perform comparisons across the whole image, the zone estimator 305 is configured to limit the area of comparison. The effect is similar to that of FIGS. 3A and 5A, but is achieved without the use of crude zone masks from a crude zone classifier 303. In this example, the current depth frame 102 and/or the current colour frame 101 is used to generate an approximate estimate 502B of regions that are in zone 1. For example, a neural network may be trained to identify regions that are likely to be within zone 1 and/or depth thresholding may be applied to the current depth frame 102 to identify regions that are likely to be within zone 1. The region identified as likely to be within zone 1 is represented in FIG. 5B as 511B. An area of uncertainty (represented by 506B in FIG. 5B) may then be determined using the approximate estimate 502B in the same way as the area of uncertainty 506 described above, for example by dilating and eroding black area 511B and then subtracting one from the other, or in any other suitable way. The area of uncertainty 511B can then be used to help limit the area of comparison for the similarity assessment 507. The similarity assessment can then be performed as described above with reference to FIG. 5A.

In the examples of FIGS. 3A, 3D, 5A and 5B, the zone estimator 305 generates the first pixel mask 314 based on the colour of at least some of the pixels in the current colour frame 101 and the colour of corresponding pixels in the reference colour frame 313 to determine whether those pixels of the current colour frame 101 are imaging the same part/location/object surface of the scene as the corresponding pixels of the reference colour frame 313. The zone estimator 305 may do this in many different ways, some examples of which are described below.

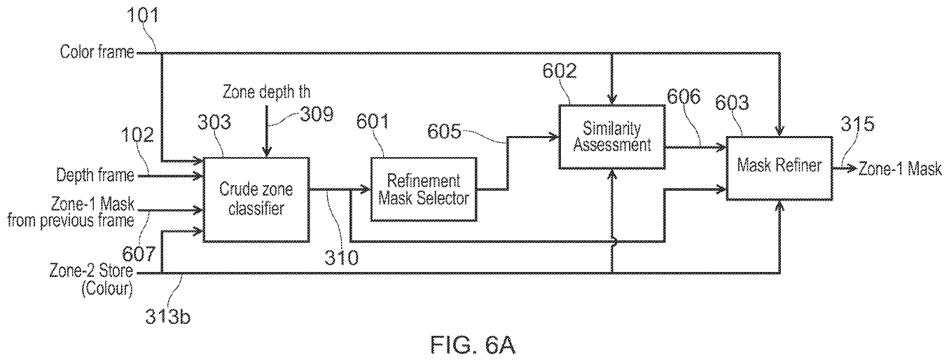

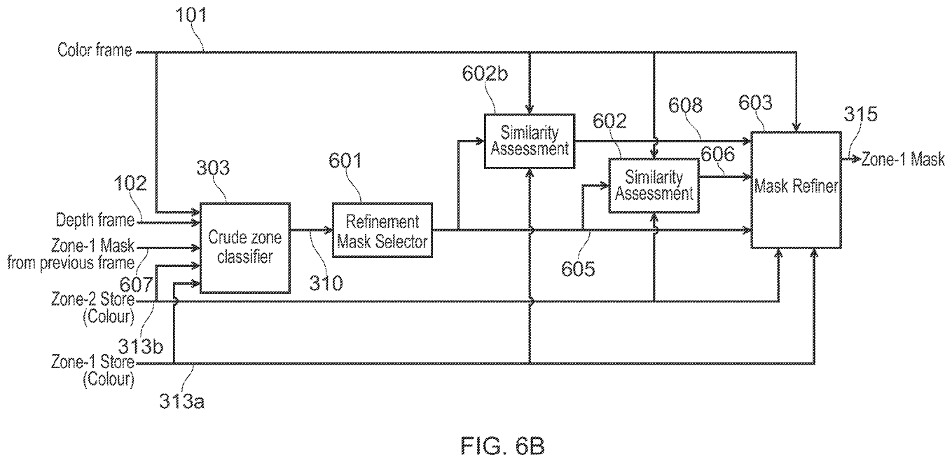

FIG. 6A shows an example representation of functions of the crude zone classifier 303 and the zone estimator 305 for determining the first pixel mask 315 in accordance with an example implementation. In the alternative example of FIG. 3D, the zone estimator 305 may optionally reduce its area of comparison by performing at least some of the functions of the crude zone classifier 303. The crude zone classifier 303 receives at least one of: the current depth frame 102; the threshold(s) 309 defining at least the first depth range (in this particular example, the foreground depth range); the current colour frame 101; a previous first pixel mask 607 (a first pixel mask that identifies the pixels imaging parts of the scene that are in the first depth zone-in this example the foreground-that was earlier determined for a frame that precedes the current frame); and/or the reference colour frame 313b for the reference depth zone (in this particular example, a second depth zone, such as the background). Whilst FIG. 6A shows the crude zone classifier 303 receiving all of these inputs, this is just for the sake of showing all possibilities and the crude zone classifier 303 may alternatively receive only one or more of these items of data. Likewise, whilst FIGS. 3A and 3B show the crude zone classifier 303 receiving the current depth frame 102 and the threshold(s) 309, it may alternatively receive only one or more of the items of data represented in FIG. 6A.

The crude zone classifier 303 may use any or all of these received data to determine the crude zone 1 mask 310 described earlier. For example, it may receive the current depth frame 102 and the threshold(s) 309 and determine the crude zone 1 mask 310 as described earlier with reference to FIG. 5A. Additionally or alternatively, it may receive the current colour frame 101 and the reference colour frame 313b and make a basic attempt at identifying which pixels are imaging parts of the scene in the first depth zone by using known object detection techniques, such as using a trained neural network. Because in this particular example, the reference colour frame 313b is for zone 2 and there are only two zones in the scene, the crude zone classifier 303 may use object detection techniques to identify pixels of the current colour frame 101 that do not appear to be imaging the same things as shown in the reference colour frame, and include those identified pixels in the crude zone 1 mask 310. Alternatively, the reference colour frame may be the zone 1 reference colour frame 313a, in which case the crude zone classifier 303 may identify pixels of the current colour frame 101 that appear to be imaging the same things as shown in the reference colour frame 313a and include those identified pixels in the crude zone 1 mask 310. Additionally or alternatively, the crude zone classifier 303 may receive the previous first pixel mask 607 and use that to set the crude zone 1 mask 310, which may be very effective in cases where the scene has not changed very much from frame to frame. The crude zone classifier 303 may use any one, or a combination of, these possibilities to set the crude zone 1 mask 310.

The refinement mask selector 601 function is an optional function of the zone estimator 305 to refine the area of the current colour frame 101 on which colour comparison will be performed. This is the function that identifies the areas of uncertainty and high confidence, as described earlier with reference to image 506 in FIG. 5A. The areas of uncertainty are identified to the similarity assessment function 602 by data 605 (which may be, for example, a pixel mask).

The similarity assessment function 602 is a function of the zone estimator 305. It compares the colour of each of the pixels in the current colour frame 101 that correspond to the areas of uncertainty to the colour of the pixels of the reference colour frame that correspond to the areas of uncertainty. For each of those pixels, a similarity score 606 (for example, a score between 0 to 1) is determined and output to the mask refiner 603 function.

The mask refiner 603 function is a function of the zone estimator 305. It generates the first pixel mask 315 based on the similarity score 606 for each of the compared pixels and based on the crude zone 1 mask 310 (which can be used to identify the area of high confidence). For each of the pixels in the area of uncertainty, the mask refiner 603 may make a decision whether or not to include them in the first pixel mask 315 based on their similarity score 606. For example, it may be a straightforward comparison to a threshold. In this particular example, because the reference colour image 313b was for zone 2 and there are only two zones in the image, a high similarity score may indicate that the pixel is likely to be imaging something in zone 2 (eg, the background). Therefore, the mask refiner 603 may assume that a relatively low similarity score 606 indicates that the pixel is imaging something outside of zone 2, eg something in zone 1 (the foreground) and then include that pixel in the zone 1 mask 315. The threshold below which a similarity score 606 is considered to be relatively low may be fixed and the same for all pixels, or it may be dynamically set by the mask refiner 603 and apply to all pixels, or on a pixel-by-pixel basis. For example, the mask refiner 603 may optionally receive the current colour frame 101 and the reference colour frame 313b (as shown in FIG. 6A) and set the threshold on a whole pixel basis, or a pixel by pixel basis, based on the current colour frame 101 and the reference colour frame 313b. For example, a colour comparison between the current colour frame 101 and the reference colour frame 313 for pixels in the area of high-confidence may indicate a degree of colour similarity that corresponds to a high-level of similarity, which could then be used to set a suitable threshold for the pixels corresponding to the similarity scores 606.

FIG. 6B is very similar to FIG. 6A, but shows a further example implementation of the crude zone classifier 303 and zone estimator 305. Again, in the alternative example of FIG. 3D, the zone estimator 305 may optionally reduce its area of comparison by performing at least some of the functions of the crude zone classifier 303. In this example, two reference colour frames are used, one 313a that images parts of the scene in zone 1 and another 313b that images parts of the scene in zone 2. The reference colour frame for zone 2 313b may be used as described above. The reference colour frame for zone 1 313a may be used by the crude zone classifier 303 to see what a colour image of zone 1 has looked like in previous frames, which in combination with the zone 1 mask 607 from a previous frame, can help in improving the crude zone-1 mask 310. Additionally, or alternatively, the zone estimator 305 may further comprise a further similarity assessment function 602b configured to assess the similarity of the pixels of the current colour frame 101 (corresponding to the area of uncertainty) and the corresponding pixels of the second reference colour frame (the zone-1 reference colour frame 313a, in this particular example) and output a similarity score 608 for each assessed pixel. This means that the mask refiner 603 may consider the similarity of each the current colour frame 101 to both of the reference colour frames 313a and 313b in order to determine which pixels of the current colour frame 101 are likely to be imaging a part of the scene that is within the first depth range.

FIGS. 6A and 6B show just some examples of how the zone estimator 305 may be configured to compare the colour of at least some of the pixels of the current colour frame 101 and the colour of corresponding pixels of at least one reference frame in order to generate a first pixel mask that identifies each of the pixels of the current colour frame that are likely to be imaging a part of the scene (eg, an object surface/location in the scene) that is within a first depth range. There are many other ways in which the zone estimator 305 may perform this comparison. For example, any one or more of the functions described above may be performed by a suitably trained neural network. For example, the similarity assessment function 602 (and further similarity assessment function 602b) and/or the mask refiner 603 may be use a neural network that is trained to perform the operations described above. The skilled person will readily appreciate how such functionality may be achieved, for example with the use of a suitable corpus of training data comprising pairs of colour frames that are annotated with similarity scores for at least some of the pixels.

Alternatively, the entire functionality of the zone estimator 305 may be implemented using a neural network that is trained to identify pixels in the current colour frame 101 that are likely to be imaging the same thing as the corresponding pixels in the reference colour frame. The skilled person will readily appreciate how such functionality may be achieved, for example with the use of a suitable corpus of training data comprising pairs of colour frames that are annotated with indications of which corresponding pixels are imaging the same thing and which corresponding pixels are not, or with synthetically generated colour frames created by combining of real colour frames of capturing imagery of separate objects.

In the example above, when one reference colour frame is used, it may typically be a reference colour frame for a different zone to the zone for which the pixel mask is being determined. In particular, the first pixel mask in the examples above is for a foreground depth range, which is zone 1, and the reference colour frame is made up of pixels from one or more previous colour frames, where those pixels image parts of the scene (eg, at least one object surface) that are in the background depth range, which is zone 2. This may be particularly beneficial when the reference colour frame is for a zone that is relatively more “stable” (i.e., tends to change less over time) than the zone of the pixel mask, which may often (but not always) be the case for background zones compared with foreground zones. Therefore, in this case, the reference depth range is different to, and non-overlapping with, the first depth range of the first pixel mask. In this case, the first pixel mask will identify pixels of the current colour frame that are determined, based on the comparison of the part of the current colour frame and the reference colour frame, as unlikely to be imaging the same part of the scene (eg, object surface) as that imaged by the corresponding pixels in the reference colour frame. However, in an alternative, the reference colour frame may be for a reference depth range that is the same as the first depth range. In this case, the first pixel mask will identify pixels of the current colour frame that are determined, based at least on the comparison of the part of the current colour frame and the reference colour frame, as likely to be imaging the same part of the scene (eg object surface) as that imaged by the corresponding pixel in the reference colour frame. In a further alternative, two or more reference colour frames may be used, for example as shown in FIG. 6B. In a further alternative, where there are three or more depth zones, the colour of at least part of the current colour frame 101 may be compared against the colour of corresponding pixels of two or more reference colour frames (each reference colour frame being for a different depth range). Each of the two or more reference colour frames may be for a different depth range to that of the pixel mask being determined. For example, there may be three depth ranges and the first pixel mask may be for a first depth range whilst the two reference colour images to which it is compared may be for the second and third depth ranges. The system may be configured to assign a pixel to the first pixel mask if it is determined that it is not likely to be imaging the same part of the scene as imaged by the corresponding pixels in the two reference depth frames. In such an implementation, the two reference colour frames may be considered to be imaging the most “stable” of the three depth ranges (often, but not always, the most distant depth ranges from the camera). Once the first pixel mask is determined, a second pixel mask for the second depth range may be determined by comparing the current colour frame 101 to a reference colour frame for the third depth range, which might be the most stable of the three depth ranges. Pixels that are not included in the first pixel mask and that are determined to be unlikely to be imaging the same part of the scene as that imaged by the corresponding pixels in the reference colour frame for the third depth range.

As briefly explained earlier, the refinement mask selector 601 function is optional and the zone estimator 305 may alternatively perform the colour comparison on all pixels identified in the crude zone-1 mask 310. In a further alternative, the crude zone classifier 303 is optional and the zone estimator 305 may alternatively perform the colour comparison on all pixels of the current colour frame 101.

The above explanation of the zone estimator 305 operation focuses particularly on the generation of the first pixel mask for zone 1 315. However, it may additionally determine a pixel mask for any of the other zones defined by the zone definer 302. For example, it may additionally generate a second pixel mask 315 that identifies each of the pixels in the current colour frame 101 that are likely to be imaging a part of the scene (eg, an object surface) that is in the second depth range (the background depth range in the example above). There are various ways in which this may be done.

In one example, the zone estimator 303 may generate the second pixel mask 315 in an analogous way to that described above for the first pixel mask 314. For example, FIG. 5A shows an example image 505 representing a crude zone-2 pixel mask 311, using which the zone-2 mask 315 may be generated by the zone estimator 305 in an analogous way to that described above (for example, with a colour comparison against at least one reference colour frame, such as the zone 1 reference colour frame and/or the zone 2 reference colour frame and/or reference colour frames for any other depth range defined by the zone definer 302). In an alternative, if there are only two zones, the zone estimator 305 may generate the second pixel mask 315 by inverting the first pixel mask 314, on the assumption that any pixels that are determined to unlikely to be imaging a part of the scene in the first depth range (eg, pixels not included in the first pixel mask 314) are likely to be imaging a part of the scene in the second depth range.

In each of the examples given above, the zone estimator 305 determines the first pixel mask 314 (and optionally second pixel mask 315) in part using the reference colour frame(s) 313a/b. However, in an alternative the zone estimator 305 may determine the first pixel mask 314 (and optionally second pixel mask 315) without using any reference colour frames and the zone store 304 may be omitted.

FIG. 3C shows an example of this. In this example, the zone estimator 305 may determine the first pixel mask 314 (and optionally second pixel mask 315) using the current colour frame and/or current depth frame 102. Any suitable techniques may be used, for example using neural networks that are trained by a suitable corpus of training material to generate the first pixel mask 314 (and optionally second pixel mask 315) using the content of the current colour frame and/or current depth frame 102. Alternatively, it may simply use the current depth frame 102 to set the first pixel mask 314 (and optionally second pixel mask 315) using the depth information in the current depth frame 102, in which case the first pixel mask 314 may correspond to the image 504 in FIG. 5A. Whilst such a pixel mask may not have the accuracy or refinement of the pixel masks generated by the configurations of FIGS. 3A and 3D, it may nevertheless be sufficiently accurate for some application and may have the benefit of faster and more efficient generation.

In all of FIGS. 3A to 3D, the error identifier 301 further comprises a depth invalidator 306 configured to generate a marked depth frame 316 by marking as incorrect any pixels of the current depth frame 102 that correspond to the pixels of the first pixel mask 314 and that have a depth value that is outside of the first depth range. Additionally, it may also mark as incorrect any pixels of the current depth frame 102 that correspond to the pixels of any other pixel mask(s) generated by the zone estimator 305, such as the second pixel mask 315, and that have a depth value that is outside of the depth range for that pixel mask(s), such as the second depth range. The depth invalidator 306 may receive the current depth frame 102, the threshold(s) 309 identifying the first depth range (and optionally the second depth range and any other depth ranges), the first pixel mask 314 and optionally any other pixel masks, such as the second pixel mask 315. Any pixels of the current depth frame 102 that correspond to the pixels of the first depth mask 314 and have a depth value outside of the first depth range may be marked as incorrect in any suitable way, for example by deleting those depth values or otherwise setting a flag indicating that they are incorrect. Likewise, the same may be done for the pixels corresponding to the second depth mask 315 (and any other depth masks if there are more than two depth zones).

The marked depth frame 316 should therefore have fewer incorrect or inaccurate depth values compared with the current depth frame 102, since pixels that are actually imaging a part of the scene in one zone, but in the current depth frame 102 have a depth value in corresponding to a different zone, should be marked as incorrect in the marked depth frame 316 (for example, the depth value is deleted from the marked depth frame 316).

The marked depth frame 316 is output from the error identifier 301 and may be useful for a variety of different applications and/or purposes. In some instances it may be useful without further modification, since whilst it may include a number of holes (eg, missing depth values), the depth values that are present should provide a more accurate and reliable image of the captured scene since there should be few, or no, incorrect/inaccurate pixels. In other instances, further modifications may be made, for example by correcting the pixels that have been marked as incorrect.

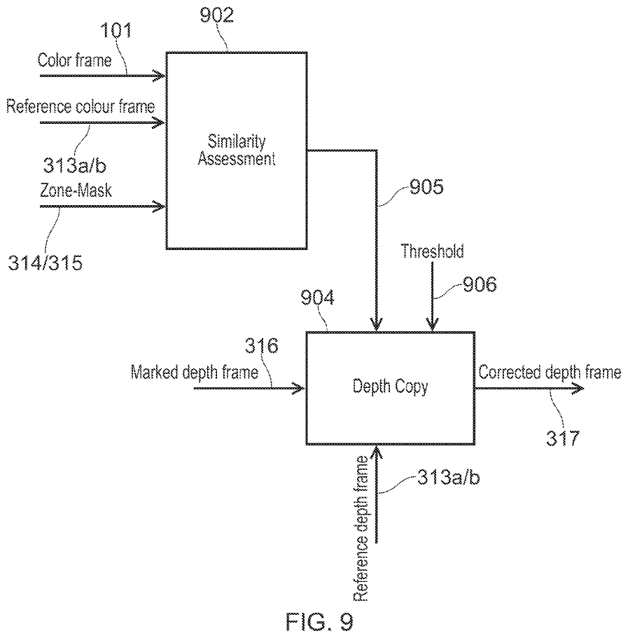

FIGS. 3A to 3D include a zone aware depth filler 307 that is configured to correct pixels that have been marked as incorrect. It is referred to as a “filler” because in this example the pixels marked as incorrect are deleted by the depth invalidator 306 such that the marked depth frame 316 will include holes (some of which will be caused by the depth invalidator 306 and others of which may have been missing from the current depth frame 102 all along). FIG. 9 shows a schematic representation of one example implementation of the zone aware depth filler 307 of FIGS. 3A, 3B and 3D. The zone aware depth filler 307 of FIG. 3C may be implemented in a different way, as explained later.

The zone aware depth filler 307 of FIG. 9 includes a similarity assessment function 902 configured to determine/assess, for each zone, the similarity of each pixel in the current colour frame 101 to the corresponding pixel in the reference colour frame 313a/b. For example, it may use the zone-1 mask 314 to identify zone 1 pixels in the current colour frame 101 and determine their similarity to the zone 1 reference colour frame 313a, and use the zone-2 mask 315 to identify zone 2 pixels in the current colour frame 101 and determine their similarity to the zone 2 reference colour frame 313b. For each reference colour frame 313a/b, the zone store 304 also stores a corresponding reference depth frame 313a/b (as mentioned earlier). Therefore, the zone-1 reference 313a comprises a zone-1 reference colour frame and a zone-1 reference depth frame that each image the parts of the scene (eg, object surfaces) that are within the first depth range. They each comprise pixels made up from one or more previous colour and depth frames.

The zone aware depth filler 307 may further comprise a depth copy function 904. The similarity assessment function 902 may provide, to the depth copy function 904, data 905 that indicates the similarity of each pixel of the current colour frame 101 to the corresponding pixels of the reference colour frames. Using this, the depth copy function 905 can determine for each depth zone whether missing depth values in the marked depth frame 316 may be filled with the depth values in the corresponding pixels of the first and second reference depth frames 313a/b. The threshold 906 may set the minimum amount of colour similarity at which the depth copy function 904 can decide that a particular pixel in the current frame 101/102 is imaging the same thing as the corresponding pixel in the reference frame 313a/b, in which case the depth value for that pixel in the reference depth frame 313a/b can be inserted as the depth value for that pixel in the marked depth frame 316. Thus, the zone aware depth filler 307 generates the corrected depth frame 317 by filling the holes in the marked depth frame 316 with depth values taken from the reference depth frames 313a/b when it is considered safe to do so.

This is merely one example of how the corrected depth frame 317 may be generated. Additionally, or alternatively, the corrected depth frame 317 may be generated using the marked depth frame 316 in any other suitable way. One example is replacing depth pixels that are marked as incorrect (eg, that are holes) in the marked depth frame 316 with depth values that are determined based on one or more neighbouring pixels. This may include averaging the depth values of pixels that neighbour a pixel marked as incorrect and/or interpolating or extrapolating a depth value using the depth values of the neighbouring pixels. Preferably, the neighbouring pixels may only be neighbouring pixels that are within the same depth zone as the pixel that is marked as incorrect (which can be determined using the pixel mask 314/315 for the depth in which the marked pixel is located). For example, a pixel in the marked depth frame 316 that is identified as incorrect may correspond to a pixel in the second pixel mask 315 (eg, it has been identified as imaging something that is within the second depth range). In the case, other pixels in the marked depth frame 316 that correspond to pixels in the second pixel mask 315 (i.e., other pixels that have been identified as also imaging something that is within the second depth range) may be used to help correct/fill the pixel was marked as incorrect. Pixels in the marked depth frame 316 that do not correspond to pixels in the second pixel mask 315 (i.e., pixels that have been identified as imaging something that is outside of the second depth range) may not be used to help correct/fill the pixel was marked as incorrect. This helps to minimise the chance of bleed or blurring in the event that the pixel that is marked as incorrect is at or near a boundary between depth zones. Such an example implementation may be used for the example implementations of any of FIGS. 3A to 3D, since it does not require any reference frames 313a/b.

Returning now to FIG. 3B, the functionality of the error identifier 301 after generating the modified depth frame (eg, the marked depth frame 316 or corrected depth frame 317) shall now be described (the so called “second state”). In this state, the boundaries of one or more or the depth zones may be updated/refined by the zone definer 302 and/or the reference colour and depth frames 313a/b for each depth zone may be updated by the zone store 304. This state of operation is fully applicable to the example configuration of FIG. 3D, and is also applicable to the configuration of FIG. 3C for the update/refinement of boundaries of one or more or the depth zones, but not for the update of reference colour and depth frames 313a/b, since the configuration of FIG. 3C does not include a zone store 304.

Starting with the zone definer 302, the boundaries of one or more of the depth ranges may be updated using the current depth frame 102 and/or the marked depth frame 316 and/or the corrected depth frame 317 (FIG. 3B only shows the zone definer 302 receiving the current depth frame 102 for the sake of simplicity, but it may additionally or alternatively receive the marked depth frame 316 and/or the corrected depth frame 317). The updated/refined depth range may then be used for the processing of the next depth frame 102 that will be received in the plurality of time-consecutive frames. The zone definer 302 may update/refine the boundaries of at least one of the depth zones by performing the assessment described above with reference to FIG. 4 and integrating the determined depth thresholds with those that the zone definer 302 determined using a number of the preceding frames (for example, the preceding five, 10, 15, etc frames in the time-consecutive plurality of frames). In this way, changes to the depth thresholds that are set by the zone definer 302 may be gradual over time and oscillations in the thresholds may be avoided. This integrating, or filtering, can effectively provide a degree of damping in the way in which the zone thresholds are set. However, the zone definer 302 may optionally be configured to update the boundaries of one or more of the depth zones using a more intelligent filtering function that allows the thresholds to change more rapidly when the captured scene changes rapidly (for example, when a person in the scene moves quickly), and more slowly when there are more minor and gradual changes in the scene. Optionally, the zone definer 302 may change which of the current depth frame 102 and/or marked depth frame 316 and/or corrected depth frame 317 it uses. For example, it may initially use the current depth frame 102 and then after a period of time, after which the system has developed knowledge of the scene and is generating high quality marked depth frames 316 and/or corrected depth frames 317, it may switch to either or both of those.

Furthermore, whilst updating at least one of the depth ranges has been described as taking place after the marked depth frame 316 and/or corrected depth frame 317 have been generated, in an alternative the zone definer 302 may use the current depth frame 102 to update a depth range(s) and then use the updated depth range(s) in order to identify incorrect pixels in the current depth frame 102 (and optionally also correct those identified incorrect pixels). This is particularly true if the depth zones are updated in a way that integrates, or damps, changes over time. In any event, the boundaries of the depth ranges may be set and optionally updated/refined in any suitable way using the current depth frame 102 and/or marked depth frame 316 and/or corrected depth frame 317.

Turning now to the zone store 304, the function of the zone store 304 is to hold a first reference depth frame and first reference colour frame (together shown as 313a in FIG. 3B) and a second reference depth frame and second reference colour frame (together shown as 313b in FIG. 3B). If there are further depth zones, reference depth and colour frames will also be held for each of those further depth zones. Each reference colour/depth frame is intended to be the most complete possible colour/depth image for the depth zone. For example, in the above example where zone 2 is the background zone of the scene, the zone-2 reference colour frame should be a colour image of as much of the background as possible, and the zone-2 reference depth frame should be a depth image of as much of the background as possible. Therefore, the zone-store 304 is configured to update the reference frames over time so that as new/additional parts of each zone become visible over time, they are incorporated into the reference frames so that the reference frames are effectively a composite of multiple earlier colour/depth frames.

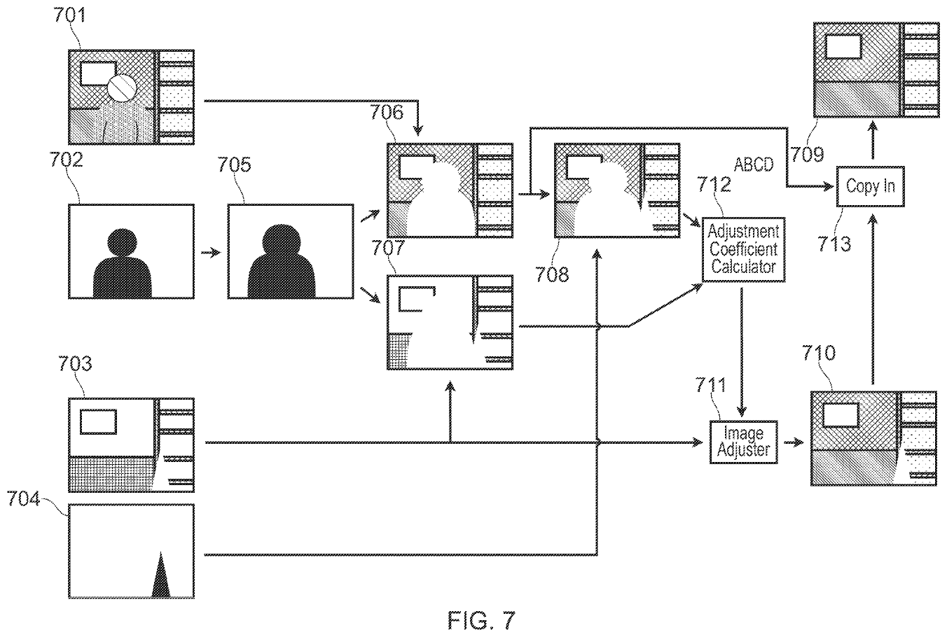

FIG. 7 shows a visualisation to help explain the process of updating the reference frames held by the zone store 304.

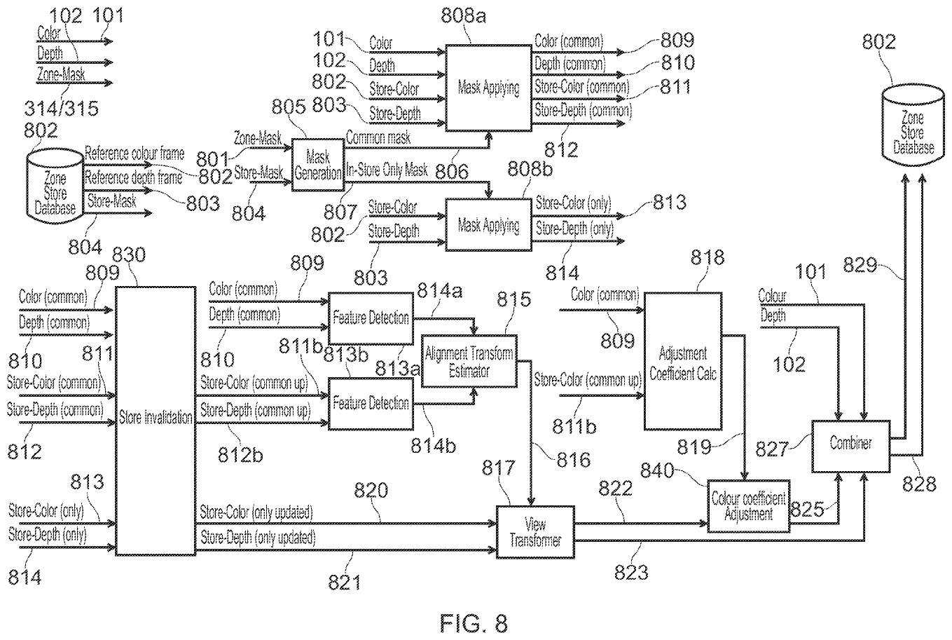

FIG. 8 shows example functions that the zone store 304 may be configured to perform.

Starting with FIG. 7, a visualisation of updating the reference colour frame for a background zone (eg, zone 2 in the examples above) is shown. The image 701 represents the current colour frame 101, image 702 represents a pixel mask for another depth zone (in the particular example described earlier, it is the foreground, or zone 1, pixel mask 314) and image 703 represents the zone 2 reference colour frame 313a that is currently held by the zone store 304. There is a part of the background that the system has never previously seen, which can be seen as a white triangle in the bottom right of the image 703. This part is represented by the black triangle in image 704. The zone store 304 may also have a store mask for each depth zone, each store mask indicating the pixels of the reference depth/colour frame for which it has information/values. In the example of image 703, the zone 2 store-mask would identify all of the white pixels of image 704, since those are the pixels for which it has colour information in the zone 2 reference colour/depth frame 313b.

Turning to FIG. 8, the zone store 304 receives the current colour frame 101, the current depth frame 102 (or alternatively the marked depth frame 316 or the corrected depth frame 317) and the zone masks 314/315. The zone store database 802 holds the reference colour and depth frames 313a/b and the store masks. The zone store 304 in this example includes a further mask generation function 805 that is configured to identify parts of each zone reference frame that are also visible in the current colour/depth frame, and the parts that are visible only in the reference frame.

To simplify the explanation, we shall describe in detail an example process of updating a particular reference colour frame, in this example the zone 2 reference colour frame. However, the zone store 304 may update each reference colour frame and each reference depth frame in the same way. In this example, the reference colour frame 802 is the zone 2 reference colour frame 313b and the reference depth frame 803 is the zone 2 reference depth frame 313b. The store-mask 804 in this case is the store mask identifying all of the pixels of the zone 2 colour/depth reference frame 313b that have values.

The zone store 304 may include a mask generation function 805 that obtains the store mask 804 from the database 802 and, in this particular example, the zone 1 pixel mask 314 (although it could additionally or alternatively obtain and use any other zone masks, such as the zone 2 pixel mask 315). Using these two masks, it determines zone 2 pixels of the current colour and depth frames 101,102 that are also visible in both the zone 2 colour/depth reference frame 313b (referred to from here on as “common” pixels) and zone 2 pixels that are visible only in the zone 2 colour/depth reference frame 313b (referred to from here on as “store only” pixels”). An example process for doing this may be understood from FIG. 7.

Optionally, the mask generation function 805 may modify the zone 1 pixel mask 314 that it has obtained, for example by dilating it as shown by image 705 in FIG. 7. This may effectively add a safety zone to the zone 1 pixel mask 314, in case some of the edges of the mask are not quite correct. It then uses that modified mask along with the zone 2 store mask 804 to create a common pixel mask 806, which identifies the pixels that have zone 2 information in both the current frame 101/102 and the zone 2 reference frame 313b, and to create a store only mask 807, which identifies the pixels that have zone 2 information in the zone 2 reference frame 313b but not the current frame 101/102.

The common pixel mask 806 may be better understood from images 707 and 708 in FIG. 7. Image 707 shows what it would look like if the common pixel mask 806 were applied to the zone 2 reference frame 313b so that only pixels that have values in both the current frame (image 701) and the reference frame (image 703) are visible. Likewise, image 708 shows what it would look like if the common pixel mask 806 were applied to the current frame. The store only mask 807 is not really visualised in FIG. 7, but it would effectively identify the black parts represented in image 705, less any overlapping black parts represented in image 704.

In a basic implementation of the zone store 304, an updated zone 2 reference colour frame may be generated by taking the current colour frame 101, applying the zone 2 mask 315 (or a modified version of the zone 2 mask 315, such as one that is dilated as shown in image 705) to it (which results in image 706 in FIG. 7) and copying into any holes in the resultant image colour pixels that appear in only the zone 2 reference colour frame. By using as many pixels of the current colour frame 101 as possible, the updated zone 2 reference colour frame may have as much as possible of the most recent appearance of the parts of the scene that are within the second depth range. This may be particularly useful if the colour of the scene is gradually changing over time, for example if the lighting of the scene gradually changes over time. Any zone 2 gaps in the current colour frame 101 may then be filled with stored information in the zone 2 reference colour frame 313b so that the updated zone 2 reference colour frame is the most complete representation of the zone 2 content of the scene as possible.

Whilst this basic implementation would work, it has some shortcomings. The first shortcoming is inconsistencies in the visual appearance of the current colour frame 101 and the zone 2 reference colour frame 313b. For example, if the brightness of the imaged scene has changed from frame to frame (for example, because the sun has just gone behind a cloud, or an artificial light has just been turned on), the composite updated reference colour frame may have a strange visual appearance. In FIG. 7, it can be seen that the scene captured by image 701 is slightly darker than that of image 703. Therefore, whilst images 707 and 708 should have identical appearances, in practice image 708 appears slightly darker than image 707. In order to address this, the zone store 304 may be configured to adjust at least one colour coefficient of the zone 2 reference colour frame 313b (or preferably adjust the colour coefficient(s) of just the pixels of the zone 2 reference colour frame 313b corresponding to the store only mask 807, since that is more efficient) so that the visual appearance of those pixels is consistent with the visual appearance of the current colour frame 101. The image adjuster 711 in FIG. 7 shows an example of this where the adjustment is made to the whole of the zone 2 reference colour frame, which results in image 710. It can then be seen that when the store-only parts of image 710 are copied into the image 706 by the copy in function 713, it results in an updated zone 2 reference colour frame having the seamless visual appearance of image 709.

The colour coefficient adjustments that are required may be determined in any suitable way. One example technique is to compare the colours of the pixels in the current colour frame 101 and the zone 2 reference colour frame 313b that correspond to the common pixel mask 806 (eg, compare image 707 to image 708). This is what the adjustment coefficient calculator 712 in FIG. 7 does. The colour of each of these pixels should be identical, since they should each be imaging exactly the same part of the scene. Therefore, by comparing them, a colour coefficient adjustment can be calculated that, if applied to the zone 2 reference colour frame pixels that correspond to the common mask 806, would result in them matching (eg, being as similar as possible to) the colours of the current colour frame pixels that correspond to the common mask 806. That adjustment can then be applied by the image adjuster 711.

The colour coefficients may include one or more of: brightness; saturation; intensity; etc. If the colour frames are, for example, RGB frames, the adjustments may scale to R and G and B independently, or they may be offset and scale. The coefficient adjustments may be regionally divided, or may be a piece-wise system.

A further issue that may affect updating both reference colour frames and reference depth frames is that some pixels of the current depth/colour frame and/or stored reference depth/colour frame may not be reliable for use in updating the stored reference depth/colour frame. For example, some pixels may be imaging a television having a screen with a constantly changing appearance. Therefore, comparing television screen pixels in the current colour frame 101 to corresponding television screen pixels in the reference colour image in order to determine the colour coefficient adjustment is likely to result in sub-optimal outcomes. Furthermore, including in the updated reference depth/colour frames any pixels that are part of the previous reference depth/colour frame but whose values are not reliable, for example because they are regularly changing (such as a television screen) may not be desirable as those pixels are likely to look out of place in relation to any neighbouring pixels taken from the current depth/colour frame.

To address this, the zone store 304 may further include the store invalidation function 830 shown in FIG. 8. First, as can be seen in the top right of FIG. 8, the zone store 304 may generate a colour (common) frame 809 by a mask application function 808a applying the common pixel mask 806 to the current colour frame 101. Likewise, a depth (common) frame 810 may be generated by applying the common pixel mask 806 to the current depth frame 102, a store-colour (common) frame 811 may be generated by applying the common pixel mask 806 to the store-colour frame 802 (in this example, the zone 2 reference colour frame 313b) and a store-depth (common) frame 812 may be generated by applying the common pixel mask 806 to the store-depth frame 803 (in this example, the zone 2 reference depth frame 313b). Furthermore, a store colour (only) frame 813 may be generated by a mask application function 808b applying the store only mask 807 to the store-colour frame 802 (in this example, the zone 2 reference colour frame 313b), and a store depth (only) frame 814 may be generated by a mask application function 807 applying the store only mask 807 to the store-depth frame 803 (in this example, the zone 2 reference depth frame 313b).

The store invalidation function 830 may use these generated frames to generate a store colour (common updated) frame 811b and a store depth (common updated) frame 812b. These are updated versions of the store colour (common) frame 811 and store depth (common) frame respectively, where any unreliable/untrustworthy pixel values have been invalidated (eg, deleted). The unreliable/untrustworthy pixel values may be identified in any suitable way, for example by comparing the values of corresponding pixels in the colour (common) frame 809 and the store colour (common) frame 811, and comparing the values of corresponding pixels in the depth (common) frame 810 and the store depth (common) frame 812, and invalidating (eg, deleting) pixels that are different by an amount exceeding a threshold (such as a percentage threshold).

The store invalidation function 830 may optionally generate a store colour (only-updated) frame 820 and a store depth (only-updated) frame 821 that are updated versions of the store colour (only) frame 813 and the store depth (only) frame 814, where any unreliable/untrustworthy pixel values have been invalidated (eg, deleted). The unreliable/untrustworthy pixel values may be identified in any suitable way, for example by using nearby/neighbouring pixels in the common parts of the image (eg, pixels in the frames 809, 810, 811 and 812) that have been identified as being nearby or neighbouring to the store only pixels. For example, if a part of the common frames has been identified as unreliable/untrustworthy, the cause of that may be likely to affect any neighbouring store only pixels as well.

As can be seen, the adjustment coefficient calculator function 818 in FIG. 8 (which is equivalent to the function 712 in FIG. 7) uses the store colour (common updated) 811b frame to compare against the colour (common) frame 809 to determine the required coefficient adjustment. Therefore, any unreliable/untrustworthy colour pixels do not contribute to the adjustment calculation, so the colour coefficient adjustment should be more effective.

A further issue that may affect updating both reference colour frames and reference depth frames is that there might be small movements in the video camera and/or the scene between frames. For example, an object in the scene that has not moved may appear to have moved because the camera position has slightly changed between frames. This may be particularly common when the camera is a webcam on a laptop lid, or positioned on top of a computer monitor, both of which are prone to wobbling. This may result in inaccuracies when the store-only pixels are combined with the pixels of the current frame to generate the updated reference frame. Therefore, the zone store 304 may be configured to identify a feature in the current frame (eg, the current colour frame 101 or current depth frame 102) and identify the same feature in the reference colour/depth frame 802,803 that is being updated (in this particular example, the zone 2 reference colour and/or depth frame 313b). This may be done using any known object recognition techniques that will be well understood by the skilled person. The zone store 304 may then determine a transformation of the reference colour/depth frame 802, 803 that would align the feature in the reference colour/depth frame 802, 803 with the feature in the current colour/depth frame 101, 102. That transformation may then be applied to the reference colour/depth frame 802, 803 before any of its pixels are used in creating the updated reference colour/depth frame.

In the example represented in FIG. 8, feature detection is performed by the feature detection function 813a on the colour (common) frame 809 and/or depth (common) frame 810, and by the feature detection function 813b on the store colour (common updated) frame 811b and/or the store depth (common updated) frame 812b (although it may alternatively be performed on the store colour (common) frame 811 and the store depth (common) frame 812 if there is no store invalidation function 830). This should improve efficiency and speed since feature detection is performed over a smaller area and should only identify features that are common to both the current frame(s) and the reference frame(s).

The identified features are then communicated to an alignment transform estimator function 815 as data 814a and 814b, which determines the required transformation 816. This is then applied to the reference colour/depth frame by the view transformer function 817.

Preferably, the view transformer function 817 actually applies the transformation to the store colour (only updated) frame 820 and/or the store depth (only updated) frame 821 (or alternatively the store colour (only) frame 813 and the store depth (only) frame 814 if there is not store invalidation function 830), since this improves efficiency and speed. The view transformed store only colour frame 822 then has its colour coefficients adjusted by the colour/brightness adjustment function 840. Finally, the view transformed store only depth frame 823 can be combined with the pixels of the current depth frame 102 that image the relevant depth range (in this particular example, the pixels that image the zone 2 depth range), by the combiner function 827 to generate the updated reference depth frame 828 (in this particular example, the updated zone 2 reference depth frame). A visualisation of the pixels of the current depth frame 102 that image the relevant depth range may be seen in image 706 in FIG. 7. In particular, it is the pixels of the current depth frame 102 after the zone mask 314/315 (in this particular example, the zone 2 mask 315) have been applied to the current depth frame 102, or more preferably (and as represented in image 706), the current depth frame 102 after a modification of the zone mask 314/315 (in this particular example, a dilated version of the zone 2 mask 315, as represented in image 705) have been applied to the current depth frame 102.

The combiner function 827 may also generate an updated reference colour frame 829 by combining the view transformed and colour adjusted store only colour frame 825 with the pixels of current colour frame 101 that image the relevant depth range (in this particular example, the pixels that image the zone 2 depth range). The updated reference colour and depth frames 828, 829 may be stored in the zone store database 802. Optionally, they may replace the reference colour and depth frames that were previously stored in the database 802, or a historical record of reference colour and depth frames may be built up. The updated reference frames may then be used in the processing of the next depth frame in the plurality of time-consecutive depth frames.

As mentioned earlier, whilst FIG. 8 shows the zone store 304 using the current depth frame 102 for its reference frame updating process, in an alternative it may perform the same functionality but on the marked depth frame 316 or the corrected depth frame 317.

Furthermore, the functions shown in FIG. 8 may be performed in a different order, for example the colour adjustment may be made to the reference colour frame (eg, the colour (only updated) frame 820) and then that colour adjusted frame be transformed by the view transformer 817. Furthermore, any one or more of the store invalidation, view transformation and colour coefficient adjustment functions may be omitted.

Whilst the reference frame updating functions of the zone store 304 are described with reference to updating the reference colour and depth frames of just one zone (in this case, zone 2), it will be appreciated that the reference colour and depth frames of all other zones may be updated in the same way.

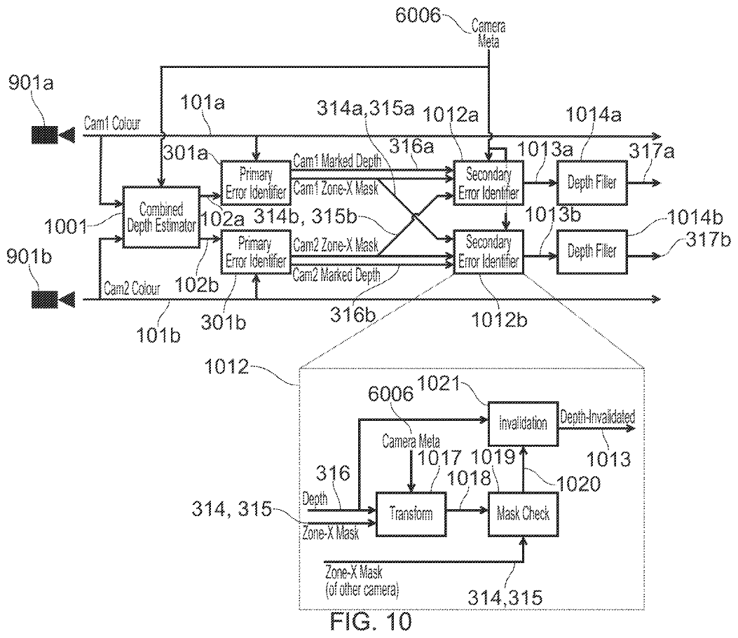

FIG. 10 shows a schematic representation of an additional optional error identification process for a two-camera system, such as that described earlier with reference to FIG. 2. Many of the features of FIG. 10 are the same as those of FIG. 2, and are identified using the same reference numerals, and those features shall not be described again now. The example of FIG. 10 shows a particular implementation of the depth correctors 1003a and 1003b of FIG. 2. In the example implementation of FIG. 10, depth corrector 1003a comprises a primary error identifier 301a, a secondary error identifier 1012a and a depth filler 1014a, and depth corrector 100b comprises a primary error identifier 301b, a secondary error identifier 1012b and a depth filler 1014b.

The primary error identifiers 301a, 301b may each operate as described above with reference to FIGS. 3a to 9, and as such may each generate and output a respective marked depth frame 316a, 316b. In addition, the primary error identifiers 301a, 301b may each generate and output one or more of the depth masks 314, 315, as described earlier. Each of the secondary error identifiers 1012a, 1012b are configured to receive the marked depth frame 316a, 316b for their camera channel, and one or more of the depth masks 314b, 315b for the other camera channel. For example, secondary error identifier 1012a receives the marked depth frame 316a for the camera a channel and one or more of the depth masks 314, 315, generated by primary error identifier 301b in relation to the camera b channel. Likewise, secondary error identifier 1012b receives the marked depth frame 316b for the camera b channel and one or more of the depth masks 314a, 315a, generated by primary error identifier 301a in relation to the camera a channel. The secondary error identifiers 1012a, 1012b may also receive camera metadata 6006, which is described earlier with reference to FIG. 2.

The secondary error identifiers 1012a, 1012b are configured to make use of the additional knowledge that is available by virtue of having two cameras imaging the same scene. In particular, the primary error identifiers 301a, 301b have determined where in the scene each zone is visible for the camera A frames, and where in the scene each zone is visible for the camera B frames. If a zone mask for a particular depth range (for example, zone 1 mask 314a) for camera A identifies an object (such as a person), the corresponding mask (for example, zone 1 mask 314b) for camera b should identify the same object in the same location. The secondary error identifiers 1012a, 1012b may utilise this observation in a number of different ways. In one implementation, they may receive the marked depth frame 316 from one channel (eg, 316a) and transform it so that it appears to image the scene from the viewpoint of the other channel/camera (eg, camera B). The transformed depth frame may then be compared against one or more of the zone masks 314, 315 that have been generated in relation to the other channel (eg, channel B). For example, zone 1 mask 314b identifies the pixels of the depth frame 102b that are likely to be imaging parts of the scene that are within the first depth range. Since the transformed version of the marked depth frame 316a is imaging the scene from the perspective of camera b, the pixels of the transformed depth frame corresponding to the zone 1 mask 314b should all be within the first depth zone. The pixels that are not may be marked as incorrect, for example by deleting them.

Another way in which the secondary error identifiers 1012a, 1012b may operate is to receive the marked depth frame 316 from one channel (eg, 316a) and receive one or more of the pixel masks 314, 315 for that channel (eg, zone 1 pixel mask 314a and zone 2 pixel mask 315a for channel A). The secondary error identifiers 1012a, 1012b may transform the pixels corresponding to at least one of the pixel masks 314, 315 (such as the zone 1 pixel mask 314a) and then identify transformed pixels that do not overlap with the corresponding pixel mask of the other channel (eg the zone 1 pixel mask 314b). The identified pixels may be marked as incorrect, for example by deleting them.

This may be understood in more detail with reference to the example detailed functions of the secondary error identifiers 1012a, 1012b that are represented in FIG. 10. Each secondary error identifier 1012a, 1012b may comprise a transform function 1017, a mask check function 1019 and an invalidation function 1021 (for example, the secondary error identifier 1012a may comprise a transform function 1017a, a mask check function 1019a and an invalidation function 1021a, etc). The operation of secondary error identifier 1012a for the camera A channel shall now be described in more detail. It will be appreciated that the secondary error identifier 1012b may be configured to operate in an analogous way.

In one implementation, the transform function 1017 uses the camera metadata 6006 to transform the marked depth frame 316a to generate the transformed depth frame 1018 that appears to image the scene from the perspective of camera b 901b. Similar operations are described earlier and the skilled person may implement this function using any known image transformation techniques. The mask check function 1019 may then apply at least one of the pixel masks 314b, 315b, that were generated in respect of the depth frames 102b for camera B and identify pixels of the transformed depth frame 1018 that correspond to an applied pixel mask 314b, 315b, but have a depth value that is outside of the depth range of the pixel mask. For example, pixels of the transformed depth frame 1018 that correspond to pixels of the zone 1 mask 314b but have a depth value that is outside of the first depth range may be identified. Each of those identified pixels may be communicated to the invalidation function 1021a as data 1020a. The invalidation function 1021a may be configured to mark as incorrect (for example, delete or flag) the depth values of any pixels of the marked depth frame 316a that transform to the pixels identified in data 1020a. For example, any pixels of the marked depth frame 316a that, when transformed by the transformation function 1017, would become the pixels of the transformed depth frame 1018 that are identified in data 1020, may be marked as incorrect by the invalidation function 1021. The resultant depth invalidated frame 1013a may then be output, for example to the depth filler 1014a.

In another implementation, the transform function 1017 uses the camera metadata 6006 to transform the pixels of the marked depth frame 316a that correspond to at least one of the pixels masks 314a, 314b (for example, the zone 1 pixel mask 314a) to generate the transformed depth frame 1018 that appears to image those parts (eg, the zone 1 parts) of the scene from the perspective of camera b 901b. Similar operations are described earlier and the skilled person may implement this function using any known image transformation techniques. The mask check function 1019 may then identify pixels of the transformed depth frame 1018 that do not overlap with the corresponding pixel mask 314b, 315b of the other channel (eg, the zone 1 pixel mask 314b for camera B). Each of those identified pixels may be communicated to the invalidation function 1021a as data 1020a. The invalidation function 1021a may be configured to mark as incorrect (for example, delete or flag) the depth values of any pixels of the marked depth frame 316a that transform to the pixels identified in data 1020a. For example, any pixels of the marked depth frame 316a that, when transformed by the transformation function 1017, would become the pixels of the transformed depth frame 1018 that are identified in data 1020, may be marked as incorrect by the invalidation function 1021. The resultant depth invalidated frame 1013a may then be output, for example to the depth filler 1014a.

The depth fillers 1014a, 1014b may be configured as described earlier with reference to FIG. 9.

By using the secondary error identifiers 1012a, 1012b, the accuracy and completeness of depth error identification that is achieved by the system may be even further improved.

Whilst in the above, the secondary error identifiers 1012a and 1012b operate on the marked depth frames 316a, 316b, in an alternative they may operate on the depth frames 102a, 102b, or on the corrected depth frames 317a and 317b (in which case, depth filling may be performed twice, once on the marked depth frames 316a, 316b, and then again on the depth invalidated frames 1013a, 1013b).

In a further alternative, secondary error identification may be performed in relation to only one channel. For example, the secondary error identifier 1012b and depth filler 1014b may be omitted. In this case, the primary error identifier 301b may be configured to generate and output the pixel masks 314b, 315b, and may optionally generate and output the marked depth frame 316b.

In a further alternative, the depth fillers 1014a, 1014b may be omitted and the depth invalidated frames 1013a, 1013b may be utilised by a downstream application/function, since those frames may include many depth holes, but the depth values that are present should be accurate and reliable.

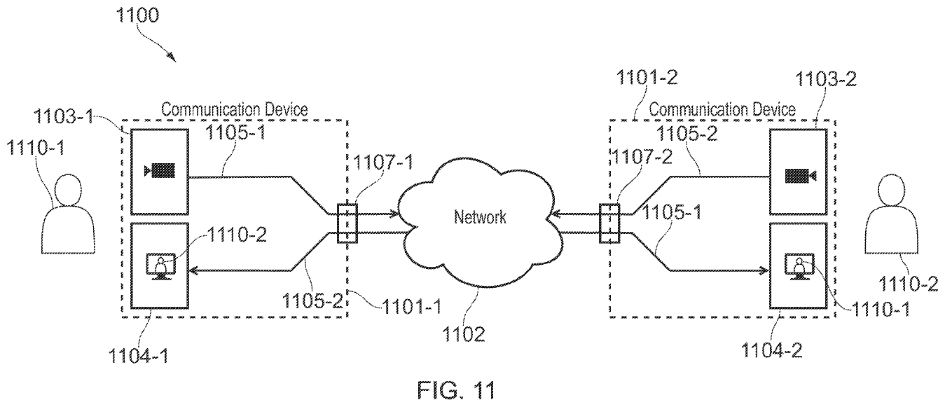

Video calling is an increasingly popular method of human-to-human interaction. For example, reference is made to FIG. 11, which shows a system 1100 which facilitates a video call between a first electronic device 1101-1 and a second electronic device 1101-2, via a network 1102. The first electronic device 1101-1 and the second electronic device 1101-2 each includes a respective video capture device or camera unit 1103-1 and 1103-2. Each video capture device/camera unit comprises at least one camera for capturing video footage. The first camera unit 1103-1 captures video footage of a first scene including a first user 1110-1 and outputs a first video stream 1105-1. The second camera unit 1103-2 captures video footage of a second scene including a second user 1110-2 and outputs a second video stream 1105-2. The first electronic device 1101-1 and the second electronic device 1101-2 each include a respective transceiver 1107-1 and 1107-2. The first video stream 1105-1 is transmitted to the network 1102 via the first transceiver 1107-1, and received by the second electronic device 1101-2 via the second transceiver 1107-2. Furthermore, the second video stream 1105-2 is transmitted to the network 1102 via the second transceiver 1107-2, and received by the first electronic device 1101-1 via the first transceiver 1107-1. The first electronic device 1101-1 and the second electronic device 1101-2 each includes a respective display 1104-1 and 1104-2. The first display 1104-1 receives the second video stream 1105-2 which is displayed by the display 1104-1. The second display 1104-2 receives the first video stream 1105-1 which is displayed on the display 1104-2.

The first video stream 1105-1 captured by the first camera unit 1103-1 will show a particular perspective or view of the first scene, based on the position of the camera unit 1103-1 within/relative to the scene. In particular, the images (i.e. frames) captured by the first camera unit 1103-1 will depend on the 3D translational and/or rotational position of the first camera unit 1103-1 within/relative to the scene. It is often the case that the first camera unit 1103-1 is positioned at some distance from the first display 1104-1. When the first user 1110-1 wants to engage directly with the second user 1110-2, the first user 1110-1 may look at the first display 1104-1 where they can see the second user 1110-2. In other words, the first user 1110-1 does not look directly at the first camera unit 1103-1. As such, from the perspective of the second user 1110-2 looking at the second display 1104-2, the first user 1110-1 will appear to be looking away from the second user 1110-2. It is impractical to position the physical camera unit 1103-1 over the display 1104-1 so that the first user 1110-1 appears to be looking directly at the camera unit 1103-1.

The real-time video processor(s) and a video processing methods of the present disclosure can be used for processing an input video stream in real-time. The video processor processes the input video stream to generate an output video stream. The output video stream will show a view of the scene that is different to the view that was captured by the original camera. In particular, the output video stream will show the scene from the perspective of a (virtual) camera that has a different position (e.g. different 3D translational and/or rotational position) within/relative to the scene in comparison to the original camera that captured the input video stream. The output video stream may be considered as an estimation of what the captured video footage would look like, had the original camera been in the position of the virtual camera.

Advantageously, the virtual camera can have a position that corresponds to the position of the display 1104-1. The video processor may alter first video stream 1105-1 so that when the first user 1110-1 is looking at the display 1104-1, the first user 1110-1 appears as though they are looking directly at the camera unit 1103-1 (and therefore at the second user 1110-2). This may improve engagement and communication of visual cues between the first user 1110-1 and the second user 1110-2 during the video call.

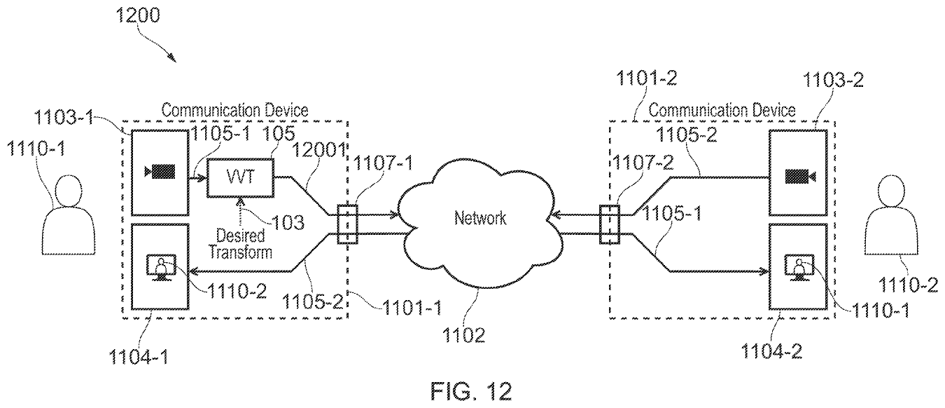

FIG. 12 shows a system 1200 according to an example of the present disclosure. The system 1200 corresponds to the system 1100 with the following differences.

As shown in FIG. 12, the first electronic device 1101-1 includes the video processor 105. The video processor 105 is in a transmit path of the first electronic device 1101-1 (i.e. between the camera unit 1103-1 and the transceiver 1107-1). The video processor 105 receives the first video stream 1105-1. The video processor 105 also receives transformation data 103. The transformation data 103 is indicative of a (3D) transformation between the actual position of the first camera unit 1103-1, and the position of a virtual camera (not shown) within the first scene. As such, the transformation data 103 indicates the desired change in view or perspective of the first video stream 1105-1. The transformation data 103 may be represented as a mathematical function. The transformation data 103 may include parameters indicative of the change in the 3D translational and/or rotational position between the camera unit 1103-1 and the virtual camera. In particular, the transformation data 103 may include translation parameters indicative of a change in a 3D translational position between the first camera unit 1103-1 and the virtual camera in 3D space. The transformation data 103 may also include rotation parameters indicative of a change in a 3D rotational position between the first camera unit 1103-1 and the virtual camera in 3D space.

The video processor 105 generates an output video stream 12001 based on the first video stream 1105-1 and the transformation data 103. In particular, for each individual frame (e.g. image) of the first video stream 1105-1, the video processor 105 applies a transformation to the image. The transformation transforms the image so that the image shows the scene from the perspective of the virtual camera instead of the first camera unit 1103-1. The transformed image may be considered as an estimation of the scene from the position of the virtual camera. The video processor 105 processes each image of the first video stream 1105-1 in real-time. The transformed images are outputted by the video processor 105 in real-time, to generate the output video stream 12001. Accordingly, the output video stream 12001 will show the video footage from the perspective of the virtual camera instead of the first camera unit 1103-1. The output video stream 12001 is then transmitted to the second user device 1101-2 via the transceiver 1107-1 and the network 1102. As such, at the second display 1104-2, the first user 1110-1 will appear to be looking directly at the second user 1110-2, when looking at the position of the virtual camera (e.g. at the first display 1104-1). Moreover, the output video stream 12001 will be free of erroneous/missing pixels or holes as a result of the inpainting techniques described herein.

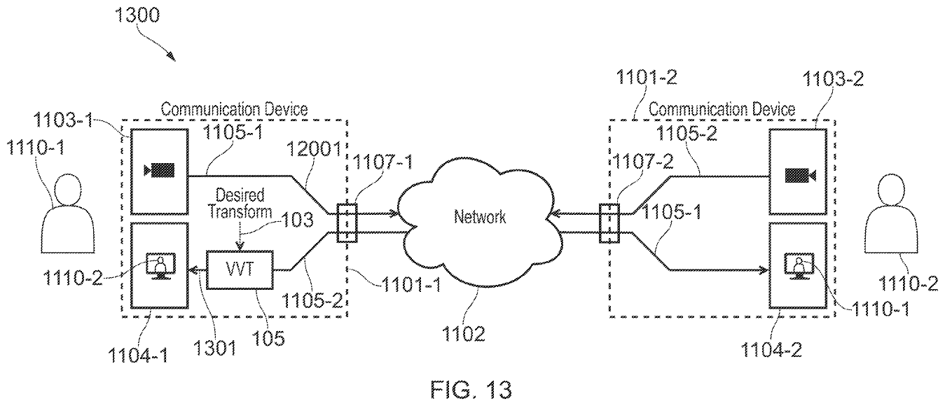

FIG. 13 shows a system 1300 according to another example of the present disclosure. The system 1300 is similar to the system 1200, except that the video processor is in the receive path of the first electronic device 1101-1 (i.e. between the transceiver 1107-1 and the display 1104-1). The video processor 105 receives the second video stream 1105-2 and the transformation data 103. In the system 1300, the transformation data 103 is indicative of a transformation between the actual position of the second camera unit 1103-2, and the position of a virtual camera within the second scene. As such, the transformation data 103 indicates the desired change in view of the second video stream 1105-2. The video processor 105 generates an output video stream 1301 based on the second video stream 1105-2 and the transformation data 103, as already described above. Accordingly, the output video stream 1301 will show the video footage from the perspective of the virtual camera instead of the second camera unit 1103-2. The output video stream 1301 is then displayed on the first display 1104-1. As such, at the first display 1104-1, the second user 1110-2 will appear to be looking directly at the first user 1110-1, when looking at the position of the virtual camera (e.g. at the second display 1104-2).

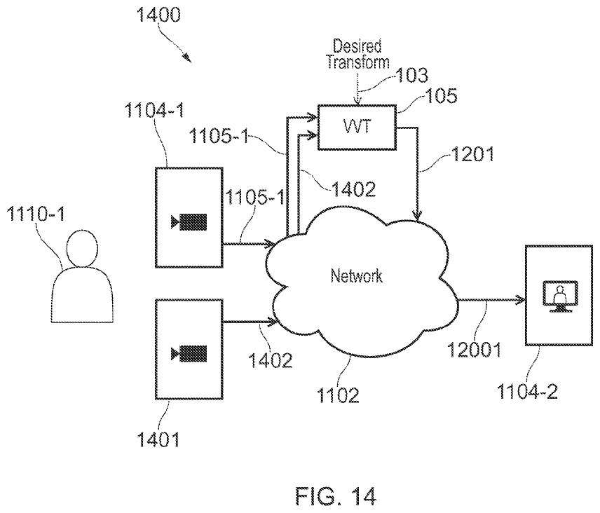

FIG. 14 shows a system 1400 according to another example of the present disclosure. The system 1400 is similar to the systems 1200 and 1300, except that the video processor 105 is not implemented in the first or second electronic devices. Rather, the video processor 105 may be implemented elsewhere in system 1400, for example elsewhere in the network 1102 (e.g. on a server, in the cloud, etc.). The video processor 105 may receive and process the first video stream 1105-1 to generate the output video stream 12001 (or receive and process the second video stream 1105-2 to generate the output video stream 1301) as described above.

The system 1400 may also include a third camera unit 1401. Like the first camera unit 1104-1, the third camera unit 1401 may also capture video footage of the first user 1110-1, but from a different position or angle to the first camera unit 1104-1. The third camera unit 1401 may output a third video stream 1402. The video processor 105 may generate the output video stream 12001 further based on the third video stream 1402. The third camera unit 1401 may be a physically separate device to the first camera unit 1104-1. The third camera unit 1401 may not be part of the first electronic device 1101-1, and may instead be independently connected to the network 1102. The third camera unit 1401 may belong to a different, third electronic device (not shown). As such, multiple independent camera units from different electronic devices can be used by the video processor 105 in order to generate the output video stream 12001.

The techniques of the present disclosure may be used in many applications and settings, including in work settings, education, entertainment and healthcare. For example, in a work setting, the systems of the present disclosure may allow two callers to have better perspectives of one another, improving interaction and engagement between the callers. In an education setting, a student may better see the education content being presented by a teacher by changing the virtual camera position. In an entertainment or streaming setting, a viewer (and many other viewers connected to the network) may view a single broadcaster whilst independently choosing a viewing position. In a healthcare setting, a physician may adjust the virtual camera position to better assess a patient.

As such, variations of the systems described herein are envisaged. It will be appreciated that either user 1110-1 or 1110-2 (or a third party) may determine the position of the virtual camera. Alternatively, the position of the virtual camera can be determined automatically. It will be appreciated that the camera units 1103-1 and 1103-2 may be part of the respective electronic devices 1101-1 and 1101-2, or physically external to the respective devices 110-1 and 1101-2 (e.g. connected to the electronic device via a wired or wireless connection). It will be appreciated that the displays 1104-1 and 1104-2 may be optional.

It will be appreciated that the systems described above may use any of the depth error identification techniques (and optionally also depth filling techniques), described herein. For example, any of the video processors 105 represented in FIGS. 12 to 14 may include an error identifier 301 that is configured to operate as described above.

The aspects of the present disclosure described in all of the above may be implemented by software, hardware or a combination of software and hardware. Any electronic device or server can include any number of processors, transceivers, displays, input devices (e.g. mouse, keyboard, touchscreen), and/or data storage units that are configured to enable the electronic device/server to execute the steps of the methods described herein. The functionality of the electronic device/server may be implemented by software comprising computer readable code, which when executed on the processor of any electronic device/server, performs the functionality described above. The software may be stored on any suitable computer readable medium, for example a non-transitory computer-readable medium, such as read-only memory, random access memory, CD-ROMs, DVDs, Blue-rays, magnetic tape, hard disk drives, solid state drives and optical drives. The computer-readable medium may be distributed over network-coupled computer systems so that the computer readable instructions are stored and executed in a distributed way.

Each of the functional modules/units described above and represented in the figures may be implemented by software, hardware or a combination of software and hardware. In one particular example, any one or more of the functional modules/units may comprise, or make use of, a trained neural network or artificial intelligence in order to perform the functionality described above. Furthermore, apparatus/system is described as a series of functional modules/units only for the sake of understanding and clarity. In practice, the functionality of any or all of the functional modules/units may be combined, and conversely the functionality of any one of the functional modules/units may alternatively be split across two or more modules/units.

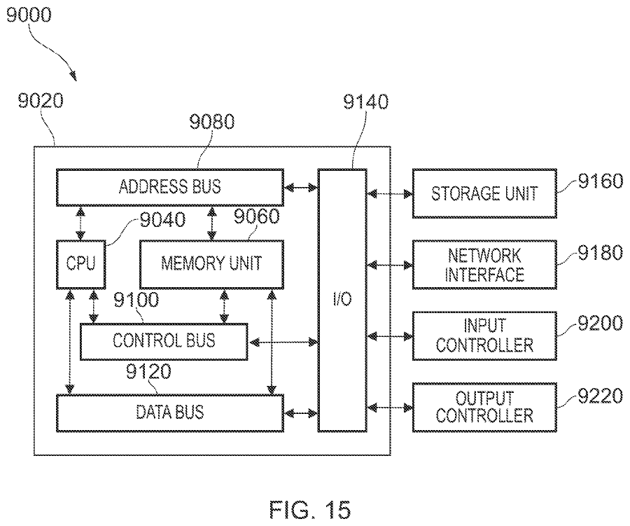

FIG. 15 shows a non-limiting example of an electronic device suitable for performing any of the above described aspects of the present disclosure. FIG. 15 shows a block diagram of an example computing system.

A computing system 9000 can be configured to perform any of the operations disclosed herein. Computing system includes one or more computing device(s) 9020. The one or more computing device(s) 9020 of the computing system 9000 comprise one or more processors 9040 and a memory 9060. The one or more processors 9040 can be any general-purpose processor(s) configured to execute a set of instructions (i.e., a set of executable instructions). For example, the one or more processors 9040 can be one or more general-purpose processors, one or more field programmable gate array (FPGA), and/or one or more application specific integrated circuits (ASIC). In one example, the one or more processors 9040 include one processor. Alternatively, the one or more processors 9040 include a plurality of processors that are operatively connected. The one or more processors 9040 are communicatively coupled to the memory 9060 via an address bus 9080, a control bus 9100, and a data bus 9120. The memory 9060 can be a random-access memory (RAM), a read-only memory (ROM), a persistent storage device such as a hard drive, an erasable programmable read-only memory (EPROM), and/or the like. The one or more computing device(s) 9020 further comprise an I/O interface 9140 communicatively coupled to the address bus 9080, the control bus 9100, and the data bus 9120.

The memory 9060 can store information that can be accessed by the one or more processors 9040. For instance, memory 9060 (e.g., one or more non-transitory computer-readable storage mediums, memory devices) can include computer-readable instructions (not shown) that can be executed by the one or more processors 9040 in order to perform the methods/processes described herein. The computer-readable instructions can be software written in any suitable programming language or can be implemented in hardware. Additionally, or alternatively, the computer-readable instructions can be executed in logically and/or virtually separate threads on the one or more processors 9040. For example, the memory 906 can store instructions (not shown) that when executed by the one or more processors 904 cause the one or more processors 9040 to perform operations such as any of the operations and functions for which the electronic device 9000 is configured, as described herein. In addition, or alternatively, the memory 9060 can store data (not shown) that can be obtained, received, accessed, written, manipulated, created, and/or stored. In some implementations, the computing device(s) 9020 can obtain from and/or store data in one or more memory device(s) that are remote from the computing system 9000.

The computing system 9000 further comprises a storage unit 9160, a network interface 9180, an input controller 9200, and an output controller 9220. The storage unit 9160, the network interface 9180, the input controller 9200, and the output controller 9220 are communicatively coupled to the computing device(s) 9020 via the I/O interface 9140.

The storage unit 9160 is a computer readable medium, preferably a non-transitory computer readable medium or non-transitory machine readable medium, comprising one or more programs, the one or more programs comprising instructions which when executed by the one or more processors 9040 cause the computing system 9000 to perform the method steps of the present disclosure. Alternatively, the storage unit 9160 is a transitory computer readable medium. The storage unit 9160 can be a persistent storage device such as a hard drive, a cloud storage device, or any other appropriate storage device.

The network interface 9180 can be a Wi-Fi module, a network interface card, a Bluetooth module, and/or any other suitable wired or wireless communication device. In one example, the network interface 9180 is configured to connect to a network such as a local area network (LAN), or a wide area network (WAN), the Internet, or an intranet.

The skilled person will readily appreciate that various alterations or modifications may be made to the above described aspects of the disclosure without departing from the scope of the disclosure.

For example, it is typically described that two or more pixel masks may be determined for a current frame (for example, the zone 1 pixel mask 314 and the zone 2 pixel mask 315). In some instances, each pixel mask may be represented by a separate data structure (for example, a data structure that sets a single value for each pixel to indicate if that pixel is part of the mask or not). In an alternative, a single data structure may be used to represent two or more pixels masks. For example, each pixel of the data structure may comprise a vector having two or more dimensions, each dimension corresponding to a depth zone/pixel mask. The values in each vector may be set to indicate the pixel mask to which that pixel belongs.

1. A method for identifying in real time incorrect pixels in depth frames of a video stream that is imaging one or more objects in a scene, wherein the video stream comprises a plurality of time-consecutive depth frames and a respective plurality of time-consecutive colour frames, the method comprising:
receiving a current depth frame of the plurality of time-consecutive depth frames and a respective current colour frame of the plurality of time-consecutive colour frames;
determining a first pixel mask for the current colour frame using at least one of: the current depth frame and the current colour frame, wherein the first pixel mask identifies each of the pixels of the current colour frame that are likely to be imaging at least one object surface that is within a first depth range; and
marking as incorrect any pixels of the current depth frame that correspond to the pixels of the first pixel mask and that have a depth value that is outside of the first depth range.

2. The method of claim 1, wherein determining the first pixel mask comprises comparing at least a part of the current colour frame to a reference colour frame that comprises a plurality of pixels that image at least one object surface that is within a reference depth range, and
wherein the reference colour frame is made up of pixels from one or more previous colour frames that precede the current colour frame in the plurality of time-consecutive colour frames.

3. The method of claim 2, wherein the reference depth range is the same as the first depth range, and
wherein the first pixel mask identifies pixels of the current colour frame that are determined, based at least on the comparison of the part of the current colour frame and the reference colour frame, as likely to be imaging the same object surface as that imaged by the corresponding pixel in the reference colour frame.

4. The method of claim 2, wherein the reference depth range is different to, and non-overlapping with, the first depth range, and
wherein the first pixel mask comprises pixels of the current colour frame that are determined, based at least on the comparison of the part of the current colour frame and the reference colour frame, as unlikely to be imaging the same object surface as that imaged by the corresponding pixels in the reference colour frame.

5. The method of claim 2, wherein the first pixel mask is determined based further on a comparison of at least a part of the current colour frame to a further reference colour frame that comprises a plurality of pixels that image at least one object surface that is within a further reference depth range.

6. The method of claim 2, wherein the comparison of the part of the current colour frame to the reference colour frame is performed by a neural network trained to determine when the part of the current colour frame is likely to be imaging at least one object surface that is within the first depth range.

7. The method of claim 2, wherein determining the first pixel mask for the current colour frame further comprises:
determining the part of the current colour frame to be compared against the reference colour frame based on at least one of:
(a) the current depth frame and the first depth range;
(b) the reference colour frame;
(c) a pixel mask for a previous colour frame that precedes the current colour frame in the plurality of time-consecutive colour frames;
(d) a further reference colour frame that comprises a plurality of pixels that image at least one object surface that is within a further reference depth range.

8. The method of claim 2, further comprising identifying a high confidence part of the current colour frame,
wherein the high confidence part comprises pixels of the colour frame that are not in the part of the current colour frame to be compared against the reference colour frame, and that are determined to be likely to be imaging at least one object surface that is within the first depth range, and
wherein the first pixel mask comprises:
the pixels of the high confidence part; and
the pixels of the part of the current colour frame that are compared to the reference colour frame and are determined, based at least on that comparison, to be likely to be imaging at least one object surface that is within the first depth range.

9. The method of claim 2, further comprising:
generating an updated reference colour frame using the reference colour frame, the first pixel mask and the current colour frame; and
storing the updated reference colour frame for use in determining at least one pixel mask for a future colour frame that that follows the current colour frame in the plurality of time-consecutive colour frames.

10. The method of claim 9, wherein generating the updated reference colour frame comprises:
generating, using at least the first pixel mask and the reference colour frame:
a common pixel mask that identifies pixels that image, in both the current colour frame and the reference colour frame, at least one object surface that is within the reference depth range; and
a reference only pixel mask that identifies pixels that image, in the reference colour frame and not in the current colour frame, at least one object surface that is within the reference depth frame;
and
generating a set of pixels using pixels of the reference colour frame that correspond to the reference only pixel mask;
wherein the updated reference colour frame comprises the set of pixels and pixels of the current colour frame that correspond to the common pixel mask.

11-12. (canceled)

13. The method of claim 9, wherein generating the updated reference frame further comprises:
identifying a feature in the current colour frame;
identifying the feature in the reference colour frame; and
determining a transformation of the reference colour frame that would align the feature in the reference colour frame with the feature in the current colour frame,
wherein generating the set of pixels comprises applying the transformation to the reference colour frame pixels corresponding to the reference only pixel mask.

14. The method of claim 1, further comprising:
marking as incorrect any pixels of the current depth frame that do not correspond to the pixels of the first pixel mask and that have a depth value that is within the first depth range.

15. The method of any preceding claim, further comprising determining a second pixel mask for the current colour frame, wherein the second pixel mask identifies each of the pixels of the current colour frame that are likely to be imaging an object surface in a second depth range; and
marking as incorrect any pixels of the current depth frame that correspond to the pixels of the second pixel mask and that have a depth value that is outside of the second depth range.

16. (canceled)

17. The method of claim 1, further comprising setting the first depth range based on range data comprising at least one of:
one or more previous depth frames that precede the current depth frame in the plurality of time-consecutive depth frames;
the current depth frame;
the previous depth frame after any incorrect pixels have been marked.

18-20. (canceled)

21. The method of claim 1, wherein the plurality of time-consecutive depth frames image the scene from a first viewpoint, and wherein the method further comprises:
receiving a further plurality of time-consecutive depth frames that image the scene from a second viewpoint;
receiving a further first pixel mask that identifies each of the pixels of a further current depth frame of the further plurality of time-consecutive depth frames that are likely to be imaging at least one object surface that is within a further depth range;
transforming the pixels of the current depth frame correspond to the first pixel mask such that a transformed current depth frame appears to image the at least one object surface from the second viewpoint;
identifying pixels of the transformed current depth frame that do not overlap with the pixels of the further first pixel mask; and
marking as incorrect the pixels of the current depth frame that transform to the identified pixels of the transformed current depth frame.

22. The method of claim 1, further comprising:
generating a corrected current depth frame by correcting at least one of the pixels of the current depth frame that have been marked as incorrect.

23. The method of claim 22, wherein generating the corrected current depth frame is based on a reference depth frame that images the scene.

24-25. (canceled)

26. The method of claim 22, wherein generating the corrected current depth frame is based on depth values of one or more neighbouring pixels that neighbour the pixels of the current depth frame that have been marked as incorrect.

27-30. (canceled)

31. One or more non-transitory computer readable media comprising computer readable instructions that, when executed by a processor, configure a data processing system to perform a method for identifying in real time incorrect pixels in depth frames of a video stream that is imaging one or more objects in a scene, wherein the video stream comprises a plurality of time-consecutive depth frames and a respective plurality of time-consecutive colour frames, the method comprising:
receiving a current depth frame of the plurality of time-consecutive depth frames and a respective current colour frame of the plurality of time-consecutive colour frames;
determining a first pixel mask for the current colour frame using at least one of: the current depth frame and the current colour frame, wherein the first pixel mask identifies each of the pixels of the current colour frame that are likely to be imaging at least one object surface that is within a first depth range; and
marking as incorrect any pixels of the current depth frame that correspond to the pixels of the first pixel mask and that have a depth value that is outside of the first depth range.

32. A system comprising: a processor, and memory storing computer readable instructions that, when executed by the processor, configure the system to perform a method for identifying in real time incorrect pixels in depth frames of a video stream that is imaging one or more objects in a scene, wherein the video stream comprises a plurality of time-consecutive depth frames and a respective plurality of time-consecutive colour frames, the method comprising:
receiving a current depth frame of the plurality of time-consecutive depth frames and a respective current colour frame of the plurality of time-consecutive colour frames;
determining a first pixel mask for the current colour frame using at least one of: the current depth frame and the current colour frame, wherein the first pixel mask identifies each of the pixels of the current colour frame that are likely to be imaging at least one object surface that is within a first depth range; and
marking as incorrect any pixels of the current depth frame that correspond to the pixels of the first pixel mask and that have a depth value that is outside of the first depth range.
